(19) United States
(12) Patent Application Publication
(10) Pub. No.: US 2019/0342524 A1
(43) Pub. Date: Nov. 7, 2019

(54) VISUAL AND/OR VIDEO MONITORING APPARATUS AND METHODS

(71) Applicant: RAYMOND ANTHONY JOAO, YONKERS, NY (US)

(72) Inventor: RAYMOND ANTHONY JOAO, YONKERS, NY (US)

(21) Appl. No.: 16/290,857

(22) Filed: Mar. 2, 2019

Related U.S. Application Data
(60) Provisional application No. 62/666,007, filed on May 2, 2018.

(51) Int. Cl. H04N 7/18; H04N 7/15; G08B 25/00; H04L 29/06

(52) U.S. Cl. CPC H04N 7/181; H04L 65/1066; G08B 25/006; H04N 7/152

(57) ABSTRACT

An apparatus, including a database, processor, receiver, and transmitter. The apparatus receives a request to visually or video monitor an individual entity, requests and receives information regarding the position or location of a monitoring computer, identifies a camera or video recording device or a plurality of same, and generates a report containing information regarding the position or location of the monitoring computer, the camera(s) or the video recording device(s), and a link or a hyperlink to a picture, a photograph, video information, or live streaming video, obtained by each camera or video recording device. The apparatus transmits the report to a user communication device. The report is viewable via a display device of the user communication device. A picture, photograph, video information, or live streaming video, is viewable via an electronic forum on the display device.

### RELATED APPLICATIONS

This application claims the benefit of the priority of U.S. Provisional Patent Application Ser. No. 62/666,007, filed May 2, 2018, and entitled “VISUAL AND/OR VIDEO MONITORING APPARATUS AND METHODS”, the subject matter and teachings of which are hereby incorporated by reference herein in their entirety.

### FIELD OF THE INVENTION

The present invention pertains to a visual and/or video monitoring apparatus and methods and, in particular, to a visual and/or video monitoring apparatus and methods which provides for the viewing and/or the visual and/or video monitoring of individuals, vehicles, and/or articles and/or other objects.

### BACKGROUND OF THE INVENTION

The problems of missing or lost individuals of all ages, and missing, lost, or stolen, vehicles and/or other articles and/or objects are not new to us in our daily lives. It is submitted that each and every day, we are faced with the reality that individuals of all ages, including infants, children, adults, and/or the elderly or the sick, can go missing for any number of reasons, that vehicles can go missing, lost, stolen, or can be the subject of a search to find and recover the same and/or their occupants, and that various types and/or kinds of articles or objects of any type, kind, or form, can be lost, stolen, or can otherwise be the subject of search and recovery efforts.

While traditional global position system (GPS) device tracking methods and techniques can be helpful in finding and in locating individuals, vehicles, and/or articles and/or objects, they can provide only limited information. For example, tracking an individuals cellular telephone can be of little use if the individual has lost possession of the same, and tracking a vehicle or an article or object equipped with a GPS tracking device can be of little help in recovering same if one cannot view or observe the same as well as the occupants and/or the person possessing the same.

As a result, there is a need for technological improvements in the fields of searching for, locating, and/or tracking and/or monitoring the movements, of individuals, vehicles, and/or articles and/or objects. It is submitted that the present invention provides such needed technological improvements in the fields of searching for, locating, and/or tracking and/or monitoring the movements, of individuals, vehicles, and/or articles and/or objects.

### SUMMARY OF THE INVENTION

The present invention pertains to a visual and/or video monitoring apparatus and methods and, in particular, to a visual and/or video monitoring apparatus and methods which provides for the viewing and/or the visual and/or video monitoring of individuals, vehicles, and/or articles and/or other objects, which overcomes the shortfalls of the prior art.

The present invention provides for the visual and/or video monitoring of individuals, vehicles, and/or articles and/or other objects. The present invention can also provide for the monitoring of audio and/or audio information associated with any visual and/or video information.

The present invention can be utilized to monitor individuals of any age. The present invention can also be utilized to monitor any motor vehicle, land vehicle, automobile, bus, mass transportation vehicle, motorcycle, scooter, bicycle, and/or any manned or unmanned vehicle. The present invention can also be utilized to monitor any article, which can be any type or kind of article of commerce, and/or any object, which can be any type or kind of object which can be the subject of visual monitoring and/or video monitoring as described herein.

The present invention provides for the visual and/or video monitoring of individuals, vehicles, and/or articles and/or other objects, by utilizing global positioning information to ascertain or to identify a location or position of a respective individual, vehicle, or article or object, and to identify one of more cameras or video recording devices at, near, or in the vicinity of, the identified location or position of the respective individual, vehicle, or article or object. The present invention can then provide video information or a picture or photograph, obtained by the identified one or more cameras or video recording devices, to a communication device or to a computer associated with, or used by, a person authorized to receive the same.

In the case of an individual, the video information or the picture or photograph can be transmitted to, and provided via a communication device, associated with, or used by, a parent, child, relative, or guardian, of, or any other person authorized to receive the same for, the individual, and/or the video information or a picture or photograph can be transmitted to, and provided via a communication device, associated with, or used by, a law enforcement agency and/or an emergency services provider agency. In the case of a vehicle or an article or object, the video information or the picture or photograph can be transmitted to, and provided via a communication device, associated with, or used by, an owner, operator, or any other person authorized to receive the same for, the vehicle or the article or object, and/or the video information or a picture or photograph can be transmitted to, and provided via a communication device, associated with, or used by, a law enforcement agency and/or an emergency services provider agency.

The present invention can be utilized in connection with, or in conjunction with, cameras and/or video recording devices which can be stationed, positioned, or located at or in public locations and/or places and/or at or in private locations and/or at or on private properties. The cameras and/or video recording devices, which can be utilized by the present invention, can be cameras and/or video recording devices which can be deployed and/or used by governmental agencies, municipalities, police departments, and/or other public or governmental entities, and can be deployed and/or used by individuals, private property owners, occupants, lessees, and/or renters, private security entities, or any other individual or entity which can deploys a camera or video recording device at a location or a place for any reason. The present invention can provide a unique technological solution in the field of providing for the monitoring of individuals, vehicles, and/or articles or objects.

The apparatus of the present invention includes a central processing computer or server computer. The central processing computer can include any number of central processing computers and/or computer systems. In this regard, the central processing computer can be a single computer or server computer or can include a plurality of any number of computers, server computers, or computer systems. The central processing computer can also be comprised of one computer or computer system and/or can be comprised of a plurality of computers or computer systems. Any number of central processing computers can be utilized in or with the apparatus of the present invention.

The central processing computer can be specially programmed and specially configured to provide all of the functionalities described herein as capable of being performed by the present invention, including, at the very least, but not limited to, the locating of an individual, a vehicle, or an article or an object, the identifying of one or more cameras and/or video recording devices positioned or located at, in, or in a vicinity of, a location of the individual, the vehicle, or the article or the object, and the providing of video information or a picture or photograph to a communication device, associated with, or used by, an authorized person or entity, a law enforcement agency, and/or an emergency services provider agency. The central processing computer can also provide audio information obtained at the location of a camera or video recording device.

The central processing computer can be associated with a private security service or entity and/or a public or governmental security service or entity, a law enforcement agency, a police department, or any other entity which can provide public safety services.

The central processing computer can also have a website or websites associated therewith, which can provide any of the data and/or information, described herein as being provided by the present invention and/or the central processing computer, as well as any of the herein-described data and/or information obtained or recorded by the herein-described camera systems and/or the mobile camera systems which can be utilized in connection, or in conjunction, with the present invention, to any of the herein-described users, individuals, or entities who or which utilize the present invention, and which can also serve as an interface for any of the users, individuals, or entities, described herein as using the present invention.

The apparatus of the present invention also includes any number of user computers or user communication devices (hereinafter “user communication device”). The user communication device can be utilized by any user, individual, party, or entity, who or which uses the present invention in order to communicate with the central processing computer(s), and/or to communicate with any of the other computers and communication devices, or with any of the camera systems or mobile camera systems, described herein as being utilized in or with the present invention.

The user communication device can communicate with, and/or can be linked with, the central processing computer(s) and/or any other computers or communication devices, or can be linked with any of the camera systems or mobile camera systems, described herein, via a wired communication network, a wireless communication network, or via any combination of wired and/or wireless communication networks.

The user communication device can be utilized by any of the herein-described users in order to interface with, and/or interact with, the central processing computer or with any of the other computers and communication devices, or with any of the camera systems or mobile camera systems, described herein as being used in or with the present invention. The user communication device can be, or can include, any communication device, a computer, a computer terminal, a terminal device connected to, or associated with, the central processing computer, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any person, individual, or entity, who or which utilizes the present invention. The user communication device can also be a server computer, a mainframe computer, a mini-computer, a microcomputer, or any other computer or device for suiting the needs of the particular user. The user communication device can also be a server computer, a network computer, or any other computer capable of being utilized in a network.

The user communication device can also be, or can include and/or be utilized in conjunction with, a network computer or any other computer which can be utilized to send and receive text messages and/or e-mail messages for or on behalf of a user. The network computer can be any computer which can be used in a computer communication network to transmit and/or receive text messages or e-mail messages to and/or from any of the herein-described user communication devices and/or can provide a text message or an e-mail message to the user communication device. The respective network computer or other computer can also automatically transmit or “push” a text message or an e-mail message or e-mail messages to a user communication device as soon as same are received and/or in real-time.

The respective network computer or computer can also serve as a conventional text message server or as an e-mail server which can allow a user to request or “pull” a text message or an e-mail message or e-mail messages to a user communication device when requested by the user or other authorized individual. Any network computer or other computer, such as one that can receive and/or send text messages or email messages from and/or to a user communication device is also considered to be a user communication device. In this regard, a text message server or an e-mail server can also be deemed to be a user communication device. Each user communication device can also have a website or websites associated therewith.

Any number of user communication devices can be utilized in, or in connection with, the present invention. The user communication devices described herein can be utilized to communicate with the central processing computer(s) and/or with any other computers or communication devices, or can communicate with any of the camera systems or mobile camera systems, described herein in a bi-directional manner.

The apparatus of the present invention also includes any number of monitoring computers. In the case of an individual who is to be monitored by the present invention, the monitoring computer can be used by, carried by, worn by, or otherwise be located at or on the person of, the individual. In the case of a vehicle or an article or object which is to be monitored by the present invention, the monitoring computer can be located in, on, or at, the vehicle or the article or object.

The monitoring computer can communicate with the central processing computer(s), the user communication devices, and/or any of the other computers and communication devices, and/or with any of the camera systems or mobile camera systems, described herein as being utilized in or with the present invention.

The monitoring computer can communicate with, and/or can be linked with, the central processing computer(s) and/or any other computers or communication devices, or can be linked with any of the camera systems or mobile camera systems, via a wired communication network, a wireless communication network, or via any combination of wired and/or wireless communication networks.

The monitoring computer can be utilized by, or in connection with, any of the individuals, vehicles, or articles, being monitored by the present invention, in order to interface with, and/or interact with, the central processing computer or with any of the other computers and communication devices, or with any of the camera systems or mobile camera systems, described herein as being used in or with the present invention. The monitoring computer can be, or can include, any communication device, a computer, a personal computer, a home computer, a laptop computer, a notebook computer, a tablet, a tablet computer, a personal communication device, a smart phone or Smartphone, a cellular telephone, a wireless telephone, a videophone, a video telephone, a personal digital assistant, a beeper or a pager, a watch, an article or item of jewelry, a smart watch, a wearable device or computer, eyeglasses, or any accessory, equipped with communications equipment, an implantable device or computer, or any combination of same, or any equivalent of same, which can be utilized to monitor any individual, vehicle, or article or object, with or using the present invention. The monitoring computer can also be a server computer, a mainframe computer, a mini-computer, a microcomputer, or any other computer or device for suiting the needs of the particular user. The monitoring computer can also be a server computer, a network computer, or any other computer capable of being utilized in a network.

The monitoring computer can also have a website or websites associated therewith, which can provide any of the data and/or information, described herein as being provided by the present invention and/or any of the central processing computer and/or the monitoring computer, to any of the herein-described users, individuals, or entities who or which utilize the present invention, and which can also serve as an interface for any of the users, individuals, or entities, described herein as using the present invention.

Any number of monitoring computers can be utilized in, or in connection with, the present invention. The user monitoring computers can be utilized to communicate with the central processing computer(s) and/or with any other computers or communication devices, or can communicate with any of the camera systems or mobile camera systems, described herein in a bi-directional manner.

It is important to note that a same device can be used as a user communication device, of a user or a first individual who is or may be monitoring a second individual, as well as a monitoring computer for the user or first individual.

The apparatus of the present invention can also include any number of camera systems. Each camera system can include one or more cameras or video recording devices, with each camera or video recording device being located at a known location or address. Each camera system can include a single camera and/or a single video recording device or can include a plurality of cameras and/or a plurality of video recording devices. The camera system can also include a microphone or audio recording device, which can be associated with each camera and/or video recording device, for recording audio information. Each camera system can also include a speaker or any number of speakers. The camera system can also be any camera and/or video recording device, which can be stationed at a fixed location, or at a number of locations, and which can be utilized to obtain and record a respective picture, photograph, video, or video information, and to provide the respective picture, photograph, video, or video information, to the apparatus and/or to the central processing computer for use in connection with the present invention.

The apparatus can utilize any number of camera systems, each of which can include a camera, cameras, a video recording device, video recording devices, a microphone, microphones, an audio recording device, audio recording devices, a speaker, and/or speakers, which can be located on any suitable structures and/or which can be stationed on or along roads, roadways, highways, parkways, and/or expressways, on buildings or other structures, in parks and/or off road premises, and/or on premises of any kind or type, and/or on public premises or private premises. In this regard, camera systems can be deployed by or on public or private premises and/or on buildings or structures by municipalities, cities, states, provinces, or the federal government, as publicly deployed camera systems, and private property owners can deploy camera systems on private premises, and/or on buildings and/or structures as privately deployed camera systems. The apparatus of the present invention can utilize a vast network of camera systems formed by the publicly deployed and the privately deployed camera systems.

Each camera or video recording device of the camera system can be located or positioned, at its respective assigned location, to obtain or record a picture, pictures, and/or video, at or in the vicinity of its assigned location. Similarly, each microphone or audio recording device, which can be assigned to and located at the location of each camera or video recording device, can record audio information in the vicinity of its respective camera or video recording device.

Each camera system can contain or include cameras and/or video recording devices which can be, or which can include, high definition cameras and/or video recording devices, wide angles lens cameras and/or video recording devices, and night vision cameras and/or video recording devices.

Each camera system can communicate with the central processing computer(s), the user communication devices, and/or any of the other computers and communication devices, and/or with any of the camera systems or mobile camera systems, described herein as being utilized in or with the present invention.

In the preferred embodiment, the camera system can communicate with, and/or can be linked with, the central processing computer(s) and/or any other computers or communication devices, or can be linked with any of the camera systems or mobile camera systems, described herein, via a wired communication network, a wireless communication network, or via any combination of wired and/or wireless communication networks.

The camera system can also interface with, and/or interact with, the central processing computer or with any of the other computers and communication devices, or with any of the camera systems or mobile camera systems, described herein as being used in or with the present invention.

The camera system can have a website or websites associated therewith, which can provide any of the data and/or information, described herein as being provided by the apparatus, the central processing computer, and/or the camera system, to any of the herein-described users, individuals, or entities who or which utilize the present invention, and which can also serve as an interface for any of the users, individuals, or entities, described herein as using the present invention.

Any number of camera systems can be utilized in, or in connection with, the present invention. The camera systems described herein can communicate with the central processing computer(s) and/or with any other computers or communication devices, or can communicate with any of the camera systems or mobile camera systems, described herein in a bi-directional manner.

The apparatus of the present invention also includes any number of mobile camera systems. Each mobile camera system can be assigned to a moving vehicle or other moving or mobile object or entity. In this regard, for example, a mobile camera system, or one or more mobile camera systems, can be assigned to and deployed on an automobile, a law enforcement vehicle, an emergency services provider vehicle, a fire department vehicle, an ambulance, any moveable structure or moveable equipment, a passenger vehicle, a mass transportation vehicle, a bus, a train, a boat, a helicopter, an aircraft, or a drone, any of which can be manned or unmanned, or any other moving object so as to provide for obtaining a picture, picture, video, or video information, at the location of the moving object or in the vicinity of the moving object at a point in time.

Each mobile camera system can include one or more cameras or video recording devices, with each camera or video recording device being located at the vehicle or other moving or mobile object or entity. Each mobile camera system can include a single camera and/or a single video recording device or can include a plurality of cameras and/or a plurality of video recording devices. The mobile camera system can also include a microphone or audio recording device, which can be associated with each camera and/or video recording device, for recording audio information. Each mobile camera system can also include a speaker or any number of speakers. The mobile camera system can also be any camera and/or video recording device, which can be stationed at the respective vehicle or other moving or mobile object or entity, and which can be utilized to obtain and record a respective picture, photograph, video, or video information, and to provide the respective picture, photograph, video, or video information, to the apparatus and/or to the central processing computer for use in connection with the present invention.

Numerous mobile camera systems can serve to form a network of mobile camera systems, each of which can include a camera, cameras, a video recording device, video recording devices, a microphone, microphones, an audio recording device, audio recording devices, a speaker, and/or speakers. The network of mobile camera systems, when utilized along with, or in conjunction with, a number of camera systems, can serve to provide for a more enhanced surveillance system infrastructure.

Each mobile camera system can include a single camera or video recording device or can include a plurality of cameras or video recording devices. The mobile camera system can also include a microphone or audio recording device for recording audio information. Each mobile camera system can also include a speaker.

Each camera or video recording device of the mobile camera system can be located or positioned, to obtain or record a picture, pictures, and/or video, at or in the vicinity of vehicle, structure, or equipment, on or at which the mobile camera system is assigned and located. Similarly, each microphone or audio recording device, which can be assigned to and located at the location of each camera or video recording device, can record audio information in the vicinity of its respective camera or video recording device.

Each mobile camera system can contain or include cameras and/or video recording devices which can be, or which can include, high definition cameras and/or video recording devices, wide angles lens cameras and/or video recording devices, and night vision cameras and/or video recording devices.

Each mobile camera system can communicate with the central processing computer(s), the user communication devices, and/or any of the other computers and communication devices, and/or with any of the camera systems or mobile camera systems, described herein as being utilized in or with the present invention.

The mobile camera system can communicate with, and/or can be linked with, the central processing computer(s) and/or any other computers or communication devices, or can be linked with any of the camera systems or mobile camera systems, described herein, via a wired communication network, a wireless communication network, or via any combination of wired and/or wireless communication networks.

The mobile camera system can also interface with, and/or interact with, the central processing computer or with any of the other computers and communication devices, or with any of the camera systems or mobile camera systems, described herein as being used in or with the present invention.

The mobile camera system can also have a website or websites associated therewith, which can provide any of the data and/or information, described herein as being provided by the apparatus, the central processing computer, and/or the mobile camera system, to any of the herein-described users, individuals, or entities who or which utilize the present invention, and which can also serve as an interface for any of the users, individuals, or entities, described herein as using the present invention.

Any number of mobile camera systems can be utilized in, or in connection with, the apparatus. The mobile camera systems described herein can communicate with the central processing computer(s) and/or with any other computers or communication devices, or can communicate with any of the camera systems or mobile camera systems, described herein in a bi-directional manner.

The apparatus also includes any number of law enforcement computers. The law enforcement computer can be utilized by any law enforcement agency, police department, or any employee or authorized agent of same, which uses the present invention in order to communicate with the central processing computer(s), and/or to communicate with any of the other computers and communication devices, or with any of the camera systems or mobile camera systems, described herein as being utilized in or with the present invention.

Each law enforcement computer can communicate with the central processing computer(s), the user communication devices, and/or any of the other computers and communication devices, and/or with any of the camera systems or mobile camera systems, described herein as being utilized in or with the present invention.

The law enforcement computer can communicate with, and/or can be linked with, the central processing computer(s) and/or any other computers or communication devices, or can be linked with any of the camera systems or mobile camera systems, described herein, via a wired communication network, a wireless communication network, or via any combination of wired and/or wireless communication networks.

The law enforcement computer can be utilized by any of the herein-described law enforcement users in order to interface with, and/or interact with, the central processing computer or with any of the other computers and communication devices, or with any of the camera systems or mobile camera systems, described herein as being used in or with the present invention. The law enforcement computer can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any law enforcement agency, police department, or any employee or authorized agent of same, which uses the present invention. The law enforcement computer can also be a server computer, a mainframe computer, a mini-computer, a microcomputer, or any other computer or device for suiting the needs of the particular user. The law enforcement computer can also be a server computer, a network computer, or any other computer capable of being utilized in a network.

The law enforcement computer can have a website or websites associated therewith, which can provide any of the data and/or information, described herein as being provided by the apparatus, the central processing computer, and/or the law enforcement computer, to any of the herein-described users, individuals, or entities who or which utilize the present invention, and which can also serve as an interface for any of the users, individuals, or entities, described herein as using the present invention.

Any number of law enforcement computers can be utilized in, or in connection with, the apparatus. The law enforcement computers can be utilized to communicate with the central processing computer(s) and/or with any other computers or communication devices, or can communicate with any of the camera systems or mobile camera systems, described herein in a bi-directional manner.

The apparatus also includes any number of emergency services provider computers. The emergency services provider computer can be utilized by any emergency services provider, police department, fire department, emergency medical services provider, or ambulance service, or any employee or authorized agent of same, which uses the present invention in order to communicate with the central processing computer(s) described herein, and/or to communicate with any of the other computers and communication devices, or with any of the camera systems or mobile camera systems, described herein as being utilized in or with the present invention.

Each emergency services provider computer can communicate with the central processing computer(s), the user communication devices, and/or any of the other computers and communication devices, and/or with any of the camera systems or mobile camera systems, described herein as being utilized in or with the present invention.

The emergency services provider computer can communicate with, and/or can be linked with, the central processing computer(s) and/or any other computers or communication devices, or can be linked with any of the camera systems or mobile camera systems, described herein, via a wired communication network, a wireless communication network, or via any combination of wired and/or wireless communication networks.

The emergency services provider computer can be utilized by any of the herein-described emergency services providers in order to interface with, and/or interact with, the central processing computer or with any of the other computers and communication devices, or with any of the camera systems or mobile camera systems, described herein as being used in or with the present invention. The emergency services provider computer can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any law enforcement agency, police department, or any employee or authorized agent of same, which uses the present invention. The emergency services provider computer can also be a server computer, a mainframe computer, a mini-computer, a microcomputer, or any other computer or device for suiting the needs of the particular user. The emergency services provider computer can also be a server computer, a network computer, or any other computer capable of being utilized in a network.

The emergency services provider computer can have a website or websites associated therewith, which can provide any of the data and/or information, described herein as being provided by the apparatus, the central processing computer, and/or the emergency services provider computer, to any of the herein-described users, individuals, or entities who or which utilize the present invention, and which can also serve as an interface for any of the users, individuals, or entities, described herein as using the present invention.

Any number of emergency services provider computers can be utilized in, or in connection with, the present invention. The emergency services provider computer can be utilized to communicate with the central processing computer(s) and/or with any other computers or communication devices, or can communicate with any of the camera systems or mobile camera systems, described herein in a bi-directional manner.

Any number of central processing computers, user communication devices, monitoring computers, camera systems, mobile camera systems, law enforcement computers, and emergency services provider computers, can be utilized in, and/or in connection with or in association with, the present invention.

Any of the central processing computers, the user communication devices, the monitoring computers, the camera systems, the mobile camera systems, the law enforcement computers, and/or the emergency services provider computer, can communicate with any other central processing computers, user communication devices, monitoring computers, camera systems, mobile camera systems, law enforcement computers, and/or emergency services provider computers, in a bi-directional manner. In this regard, any computer, communication device, camera system, or mobile camera system, described herein can communicate, in a bi-directional manner, with any other computer, communication device, camera system, or mobile camera system, regardless of whether the respective computer, communication device, camera system, or mobile camera system, is a central processing computer, a user communication device, a monitoring computer, a camera system, a mobile camera system, a law enforcement computer, and/or an emergency services provider computer.

The present invention can be utilized on, over, or via, the Internet and/or the World Wide Web. The present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

The central processing computer can include a central processing unit (CPU), a random access memory (RAM) device(s), a read only memory (ROM) device(s), a user input device(s), a display device, an output device, a receiver, a database(s), a transmitter, video and/or audio recording device(s), and a global positioning device.

The user communication device can include a central processing unit (CPU), a random access memory (RAM) device(s), a read only memory (ROM) device(s), a user input device(s), a display device, an output device, a receiver, a database(s), a transmitter, video and/or audio recording device(s), and a global positioning device.

The monitoring computer can include a central processing unit (CPU), a random access memory (RAM) device(s), a read only memory (ROM) device(s), a user input device(s), a display device, an output device, a receiver, a database(s), a transmitter, video and/or audio recording device(s), and a global positioning device.

Each of the camera system and the mobile camera system can include a central processing unit (CPU), a random access memory (RAM) device(s), a read only memory (ROM) device(s), a user input device(s), a display device, an output device, a receiver, a database(s), a transmitter, video and/or audio recording device(s), and a global positioning device. Any of the camera systems or the mobile camera systems described herein can be, or can include, an outdoor camera system(s) or an indoor camera system(s).

Each of the law enforcement computer and emergency services provider computer can include a central processing unit (CPU), a random access memory (RAM) device(s), a read only memory (ROM) device(s), a user input device(s), a display device, an output device, a receiver, a database(s), a transmitter, video and/or audio recording device(s), and a global positioning device.

The present invention can be utilized in numerous embodiments in order to provide visual monitoring and/or video monitoring of individuals, vehicles, or articles or objects. It is envisioned that any individuals, vehicles, or articles or objects, who or which are to be monitored by the present invention register or be registered with the apparatus and/or the central processing computer. It is also envisioned that those users who are authorized, designated, or assigned, to monitor an individual, a vehicle, or an article or an object, can also register or be registered with the apparatus and/or the central processing computer.

A user, who is authorized to monitor an individual, a vehicle, or an article or object, can access the central processing computer at any time and can request to obtain information for performing a visual monitoring and/or a video monitoring of or for the respective individual, vehicle, or article or object. Any authorized employee or authorized personnel of any law enforcement agency or emergency services provider can also be deemed to be authorized to perform visual monitoring and/or video monitoring of or for the respective individual, vehicle, or article or object.

The present invention can allow a user can to engage in visually monitoring and/or video monitoring the individual via the central processing computer or via an electronic forum using his or her user communication device. The user can also engage in a number of activities via the user communication device in and/or while visually monitoring and/or in video monitoring the individual. The user can select to view pictures, photographs, video information, and/or videos, or live streaming videos, obtained with or from any camera system or any mobile camera system, or from any individual camera or video recording device of same. Historical information regarding the monitoring session and movement or activities of the individual can be recorded and stored.

Pictures, photographs, video information, and/or videos, or live streaming videos, obtained with or from any cameras or video recording devices or any camera system or mobile camera system, can also be selected and viewed, by the user, via individual links or hyperlinks to the same.

Audio information recorded by any microphone(s) and/or audio recording device(s) of any camera system or of any mobile camera system can also be accessed, and listened to, by the user, such as via a link or hyperlink to the respective microphone and/or audio recording device. The user can view and visually monitor and/or video monitor the individual during the monitoring session, as well as listen to any associated audio information obtained in the vicinity of the individual.

The user can also make a report to a law enforcement agency or police department or to an emergency services provider, in the geographical area or political subdivision in which the individual is located, so as to request assistance for the individual and/or to make a report regarding any circumstances related to, or resulting from what was viewed or listened to during, the monitoring session. Law enforcement personnel and/or emergency services provider personnel can also visually monitor and/or video monitor the individual and can take any needed or suitable action to assist the individual.

The user can also, by transmitting a suitable control signal, from the user communication device, to the central processing computer, control and/or activate an operation of the monitoring computer, and/or control and/or activate an operation of any camera system, or any camera(s), video recording device(s), microphone(s), audio recording device(s), and/or speaker(s) of the camera system, and/or control and/or activate an operation of any mobile camera system, or any camera(s), video recording device(s), microphone(s), audio recording device(s), and/or speaker(s) of the mobile camera system.

The user can also cause a pre-recorded visual message, or a live visual message recorded at the user communication device, to be displayed via a display screen of or associated with a camera system(s) or a mobile camera system(s), can also cause a pre-recorded audio message, or a live audio message recorded at the user communication device, to be broadcast via a speaker of or associated with a camera system(s) or a mobile camera system(s), and/or can cause a signal or indication to be provided via the camera system(s) or mobile camera system(s), such as by providing a red light or other indication signifying that the individual is in need of assistance.

The central processing computer can record and store and/or all data and/or information provided to, and/or accessed by, the user, including, but not limited to, any reports provided by the central processing computer, any pictures, photographs, video information, videos, or live streaming videos, viewed, and/or any audio information listened to, by the user, and/or any data and/or information related thereto, the individual's movement and/or movements provided on a digitized map as provided in the electronic forum during the monitoring session, and/or any and/or all information regarding any actions taken by, and/or any activities performed by, the user in visually monitoring and/or video monitoring the individual.

The user can also initiate and/or engage in a telephone call, a video telephone call, or a video conference call, with the individual via his or her user communication device and/or the electronic forum. The present invention can be utilized to perform visual monitoring and/or video monitoring of any vehicle or any article or object in a same, similar, and/or analogous, manner in which visual monitoring and/or video monitoring can be performed for an individual.

The apparatus of the present invention, or the central processing computer, can be programmed to detect an occurrence of an event, which can result in a need or desire for the user to perform a visual monitoring and/or a video monitoring of or for a respective individual, vehicle, or article or object. Upon detecting the occurrence of the event, the central processing computer can generate a notification message and can transmit the same to the user communication device associated with, or used by, a user who is authorized to monitor the individual, the vehicle, or the article or object. Thereafter, the user can perform a visual monitoring and/or a video monitoring of the respective individual, vehicle, or article or object, via the apparatus.

The event, the occurrence of which can be detected, can be an occurrence of the individual requesting either assistance or requesting to be visually monitored and/or video monitored, with such request being made by the individual via the monitoring computer, an occurrence of an automatic request, transmitted from the monitoring computer, which can be programmed to automatically generate and transmit the request at a certain time or under certain pre-defined conditions, that the individual be visually monitored and/or video monitored, and/or the occurrence can be a request made by any other user, authorized to visually monitor and/or video monitor the individual, or made by any law enforcement agency or emergency services provider, or made by any other authorized third party, to visually monitor and/or video monitor the individual.

In the case of a vehicle or an article or object, the event, the occurrence of which can be detected, can be an occurrence of an owner or operator of the vehicle or the article or object requesting that the same be visually monitored and/or video monitored, an occurrence of the vehicle or the article or object, which can be programmed to automatically generate and transmit the request at a certain time or under certain pre-defined conditions, generate and transmit the request to be visually monitored and/or video monitored, and/or the occurrence can be a request made by any other user, authorized to visually monitor and/or video monitor the vehicle or article or object, or made by any law enforcement agency or emergency services provider, or made by any other authorized third party, to visually monitor and/or video monitor the vehicle or article or object.

The present invention can be utilized to allow an authorized user to perform visual monitoring and/or video monitoring of any individual, vehicle, or article or object, by viewing pictures, photographs, video information, videos, and/or live streaming videos, obtained by camera systems and/or mobile camera systems which are determined to be within a predetermined distance of, or within the vicinity, of the respective individual, vehicle, or article or object, which is the subject of the visual monitoring and/or video monitoring activity. The present invention can also allow an authorized user to perform any number of activities, operations, or function, while performing a visual monitoring and/or video monitoring of any individual, vehicle, or article or object.

The apparatus or the central processing computer can be programmed to detect a request made by any authorized user to visually monitor and/or video monitor an individual, a vehicle, or an article or object, and to generate a request notification report, containing information regarding the request, information regarding the requesting user, and a link or hyperlink to an electronic forum for the visual monitoring and/or video monitoring activity. Thereafter, the central processing computer can transmit the request notification report to the user communication device of or associated with each user authorized to visually monitor and/or video monitor the respective individual, vehicle, or article or object. A user receiving the request notification report can view same via his or her user communication device and/or link to the electronic forum so as to engage in, or so as to monitor or observe, the visual monitoring and/or video monitoring activity.

Any and/or all messages and/or reports can be transmitted is, as, or as an attachment to, an e-mail message, a text message, and instant message, an SMS message, a telephone call, a pre-recorded telephone call, a facsimile (fax) transmission, or an electronic transmission of any kind or type.

The apparatus and/or the central processing computer, the user communication devices, the monitoring computers, the camera systems, the mobile camera systems, the law enforcement computers, and/or the emergency services provider computers, can be programmed for automatic activation and/or operation and/or programmed activation and/or operation.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer of FIG. 1, in block diagram form;

FIG. 3 illustrates the user communication device of FIG. 1, in block diagram form;

FIG. 4 illustrates the monitoring computer of FIG. 1, in block diagram form;

FIG. 5 illustrates the camera system of FIG. 1, in block diagram form;

FIG. 6 illustrates the mobile camera system of FIG. 1, in block diagram form;

FIG. 7 illustrates the law enforcement computer of FIG. 1, in block diagram form;

FIG. 8 illustrates the emergency services provider computer of FIG. 1, in block diagram form;

FIGS. 9A and 9B illustrate a preferred embodiment method for utilizing the apparatus and methods of the present invention, in flow diagram form; and

FIGS. 10A and 10B illustrate another preferred embodiment method for utilizing the apparatus and methods of the present invention, in flow diagram form.

### DETAILED DESCRIPTION OF THE PREFERRED EMBODIMENTS

The present invention pertains to a visual and/or video monitoring apparatus and methods and, in particular, to a visual and/or video monitoring apparatus and methods which provides for the viewing and/or the visual and/or video monitoring of individuals, vehicles, and/or articles and/or other objects.

The apparatus and methods of the present invention can be utilized to monitor individuals of any age. The apparatus and methods of the present invention can also be utilized to monitor any motor vehicle, land vehicle, automobile, bus, mass transportation vehicle, motorcycle, scooter, bicycle, and/or any manned or unmanned vehicle. The apparatus and methods of the present invention can also be utilized to monitor any article, which can be any type or kind of article of commerce, and/or any object, which can be any type or kind of object which can be the subject of visual monitoring and/or video monitoring as described herein.

The apparatus and methods of the present invention provide for the visual and/or video monitoring of individuals, vehicles, and/or articles and/or other objects. The apparatus and methods of the present invention can also provide for the monitoring of audio and/or audio information associated with any visual and/or video information.

In a preferred embodiment, the apparatus and methods of the present invention provide for the visual and/or video monitoring of individuals, vehicles, and/or articles and/or other objects, by utilizing global positioning information to ascertain or to identify a location or position of a respective individual, vehicle, or article or object, and to identify one of more cameras or video recording devices at, near, or in the vicinity of, the identified location or position of the respective individual, vehicle, or article or object. The apparatus and methods of the present invention can then provide video information or a picture or photograph, obtained by the identified one or more cameras or video recording devices, to a communication device or to a computer associated with, or used by, a person authorized to receive the same.

In the case of an individual, the video information or the picture or photograph can be transmitted to, and provided via a communication device, associated with, or used by, a parent, child, relative, or guardian, of, or any other person authorized to receive the same for, the individual, and/or the video information or a picture or photograph can be transmitted to, and provided via a communication device, associated with, or used by, a law enforcement agency and/or an emergency services provider agency. In the case of a vehicle or an article or object, the video information or the picture or photograph can be transmitted to, and provided via a communication device, associated with, or used by, an owner, operator, or any other person authorized to receive the same for, the vehicle or the article or object, and/or the video information or a picture or photograph can be transmitted to, and provided via a communication device, associated with, or used by, a law enforcement agency and/or an emergency services provider agency.

In a preferred embodiment, the apparatus and methods of the present invention can be utilized in connection with, or in conjunction with, cameras and/or video recording devices which can be stationed, positioned, or located at or in public locations and/or places and/or at or in private locations and/or at or on private properties. The cameras and/or video recording devices, which can be utilized by the apparatus and methods of the present invention, can be cameras and/or video recording devices which can be deployed and/or used by governmental agencies, municipalities, police departments, and/or other public or governmental entities, and can be deployed and/or used by individuals, private property owners, occupants, lessees, and/or renters, private security entities, or any other individual or entity which can deploys a camera or video recording device at a location or a place for any reason.

The apparatus and methods of the present invention provide a unique technological solution in the field of providing for the monitoring of individuals, vehicles, and/or articles or objects.

Applicant hereby incorporates by reference herein the subject matter and teachings of U.S. Provisional Patent Application Ser. No. 62/666,007, filed May 2, 2018, and entitled “VISUAL AND/OR VIDEO MONITORING APPARATUS AND METHODS”, the subject matter and teachings of which are hereby incorporated by reference herein in their entirety.

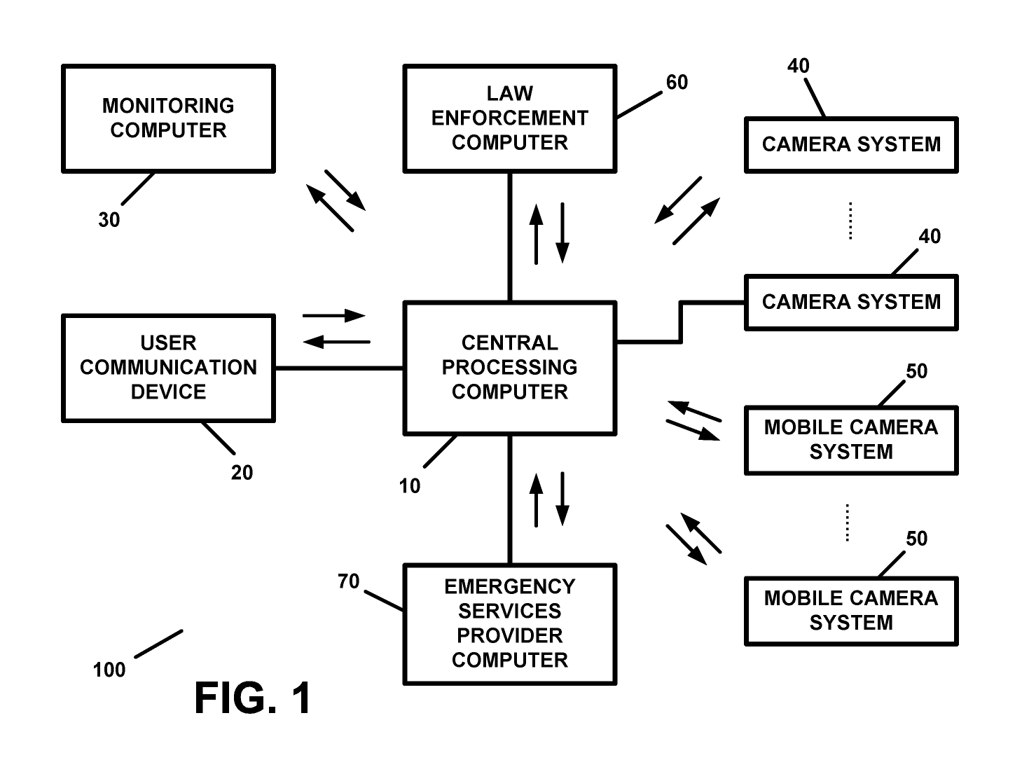

FIG. 1 illustrates a preferred embodiment of the apparatus of the present invention which is designated by reference numeral 100, in block diagram form. With reference to FIG. 1, the apparatus includes a central processing computer or server computer 10 (hereinafter “central processing computer 10”). The central processing computer 10 can include any number of central processing computers and/or computer systems. In this regard, the central processing computer 10 can be a single computer or server computer or can include a plurality of any number of computers, server computers, or computer systems. In this regard, in any and/or all of the embodiments described herein, the central processing computer 10 can be comprised of one computer or computer system and/or can be comprised of a plurality of computers or computer systems. Any number of central processing computers 10 can be utilized in the apparatus 100 of the present invention.

In the preferred embodiment, the central processing computer 10 is specially programmed and specially configured to provide all of the functionalities described herein as capable of being performed by the apparatus 100 of the present invention, including, at the very least, but not limited to, the locating of an individual, a vehicle, or an article or an object, the identifying of one or more cameras and/or video recording devices positioned or located at, in, or in a vicinity of, a location of the individual, the vehicle, or the article or the object, and the providing of video information or a picture or photograph to a communication device associated with, or used by, an authorized person or entity, a law enforcement agency, and/or an emergency services provider agency. The central processing computer 10 can also provide audio information obtained at the location of a camera or video recording device.

The central processing computer 10, in a preferred embodiment, can be associated with a private security service or entity and/or a public or governmental security service or entity, a law enforcement agency, a police department, or any other entity which can provide public safety services.

In the preferred embodiment, the central processing computer 10 will have a website or websites associated therewith, which can provide any of the data and/or information, described herein as being provided by the apparatus 100 of the present invention and/or the central processing computer 10, as well as any of the data and/or information obtained or recorded by any of the herein-described camera systems 40 and/or mobile camera systems 50 utilized in connection, or in conjunction, with the apparatus 100, to any of the herein-described users, individuals, or entities, who or which utilize the apparatus 100, and which can also serve as an interface for any of the users, individuals, or entities, described herein as using the apparatus 100 and methods of the present invention.

With reference to FIG. 1, the apparatus 100 also includes any number of user computers or user communication devices 20 (hereinafter “user communication device 20”). The user communication device 20 can be utilized by any user, individual, party, or entity, who or which uses the apparatus 100 of the present invention in order to communicate with the central processing computer(s) 10 described herein, and/or to communicate with any of the other computers and communication devices, or with any of the camera systems or mobile camera systems, described herein as being utilized in or with the apparatus 100.

In the preferred embodiment, the user communication device 20 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The user communication device 20 can be utilized by any of the herein-described users in order to interface with, and/or interact with, the central processing computer 10 or with any of the other computers and communication devices, or with any of the camera systems or mobile camera systems, described herein as being used in or with the apparatus 100. In the preferred embodiment, the user communication device 20 can be, or can include, any communication device, a computer, a computer terminal, a terminal device connected to, or associated with, the central processing computer 10, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any person, individual, or entity, who or which utilizes the apparatus 100 and method of the present invention. The user communication device 20 can also be a server computer, a mainframe computer, a mini-computer, a microcomputer, or any other computer or device for suiting the needs of the particular user. The user communication device 20 can also be a server computer, a network computer, or any other computer capable of being utilized in a network.

The user communication device 20 can also be, or can include and/or be utilized in conjunction with, a network computer or any other computer which can be utilized to send and receive text messages and/or e-mail messages for or on behalf of a user. The network computer, in the preferred embodiment, can be any computer which can be used in a computer communication network to transmit and/or receive text messages or e-mail messages to and/or from any of the herein-described user communication devices 20 and/or can provide a text message or an e-mail message to the user communication device 20. In any and/or all of the embodiments described herein, the respective network computer or other computer can also automatically transmit or “push” a text message or an e-mail message or e-mail messages to a user communication device 20 as soon as same are received and/or in real-time.

In any and/or all of the embodiments described herein, the respective network computer or computer can also serve as a conventional text message server or as an e-mail server which can allow a user to request or “pull” a text message or an e-mail message or e-mail messages to a user communication device 20 when requested by the user or other authorized individual. In this regard, any network computer or other computer, such as one that can receive and send text messages or email messages to a user communication device 20 is also considered to be a user communication device 20. In this regard, a text message server or an e-mail server can also be deemed to be a user communication device 20. In a preferred embodiment, each user communication device 20 can also have a website or websites associated therewith.

In the preferred embodiment, any number of user communication devices 20 can be utilized in, or in connection with, the apparatus 100. The user communication devices 20 described herein can be utilized to communicate with the central processing computer(s) 10 and/or with any other computers or communication devices, or can communicate with any of the camera systems or mobile camera systems, described herein in a bi-directional manner.

With reference once again to FIG. 1, the apparatus 100 also includes any number of monitoring computers 30. In a preferred embodiment, in the case of an individual who is to be monitored by the apparatus 100 of the present invention, the monitoring computer 30 can be used by, carried by, worn by, or otherwise be located at or on the person of, the individual. In the case of a vehicle or an article or object which is to be monitored by the apparatus 100 of the present invention, the monitoring computer 30 can be located in, on, or at, the vehicle or the article or object.

The monitoring computer 30 can communicate with the central processing computer(s) 10, the user communication device 20, and/or any of the other computers and communication devices, and/or with any of the camera systems or mobile camera systems, described herein as being utilized in or with the apparatus 100.

In the preferred embodiment, the monitoring computer 30 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The monitoring computer 30 can be utilized by, or in connection with, any of the herein-described individuals, vehicles, or articles, being monitored by the apparatus 100 of the present invention, in order to interface with, and/or interact with, the central processing computer 10 or with any of the other computers and communication devices, or with any of the camera systems or mobile camera systems, described herein as being used in or with the apparatus 100. In the preferred embodiment, the monitoring computer 30 can be, or can include, any communication device, a computer, a personal computer, a home computer, a laptop computer, a notebook computer, a tablet, a tablet computer, a personal communication device, a smart phone or Smartphone, a cellular telephone, a wireless telephone, a videophone, a video telephone, a personal digital assistant, a beeper or a pager, a watch, an article or item of jewelry, a smart watch, a wearable device or computer, eyeglasses, or any accessory, equipped with communications equipment, an implantable device or computer, or any combination of same, or any equivalent of same, which can be utilized to monitor any individual, vehicle, or article or object, with or using the apparatus 100 and methods of the present invention. The monitoring computer 30 can also be a server computer, a mainframe computer, a mini-computer, a microcomputer, or any other computer or device for suiting the needs of the particular user. The monitoring computer 30 can also be a server computer, a network computer, or any other computer capable of being utilized in a network.

In the preferred embodiment, the monitoring computer 30 can also have a website or websites associated therewith, which can provide any of the data and/or information, described herein as being provided by the apparatus 100, the central processing computer 10, and/or the monitoring computer 30, to any of the herein-described users, individuals, or entities who or which utilize the apparatus 100, and which can also serve as an interface for any of the users, individuals, or entities, described herein as using the apparatus 100 and methods of the present invention.

In the preferred embodiment, any number of monitoring computers 30 can be utilized in, or in connection with, the apparatus 100. The user monitoring computers 30 described herein can be utilized to communicate with the central processing computer(s) 10 and/or with any other computers or communication devices, or can communicate with any of the camera systems or mobile camera systems, described herein in a bi-directional manner.

It is important to note that a same device can be used as a user communication device 20, of a user or a first individual who is or may be monitoring a second individual, as well as a monitoring computer 30 for the user or first individual.

With reference once again to FIG. 1, the apparatus 100 also includes any number of camera systems 40. In a preferred embodiment, each camera system 40 can include one or more cameras or video recording devices, with each camera or video recording device being located at a known location or address. In a preferred embodiment, each camera system 40 can include a single camera and/or a single video recording device or can include a plurality of cameras and/or a plurality of video recording devices. In a preferred embodiment, the camera system 40 can also include a microphone or audio recording device, which can be associated with each camera and/or video recording device, for recording audio information. In a preferred embodiment, each camera system 40 can also include a speaker or any number of speakers. In a preferred embodiment, the camera system 40 can also be any camera and/or video recording device, which can be stationed at a fixed location, or at a number of locations, and which can be utilized to obtain and record a respective picture, photograph, video, or video information, and to provide the respective picture, photograph, video, or video information, to the apparatus 100 and/or to the central processing computer 10 for use in connection with the apparatus 100 of the present invention.

In the preferred embodiment, the apparatus 100 can utilize any number of camera systems 40, each of which can include a camera, cameras, a video recording device, video recording devices, a microphone, microphones, an audio recording device, audio recording devices, a speaker, and/or speakers, which can be located on any suitable structures and/or which can be stationed on or along roads, roadways, highways, parkways, and/or expressways, on buildings or other structures, in parks and off road premises, and/or on premises of any kind or type, and/or on public premises or private premises. In this regard, camera systems 40 can be deployed by or on public or private premises and/or on buildings or structures by municipalities, cities, states, provinces, or the federal government, as publicly deployed camera systems 40, and private property owners can deploy camera systems 40 on private premises, and/or on buildings and/or structures as privately deployed camera systems 40. In the preferred embodiment, the apparatus 100 can utilize a vast network of camera systems 40 formed by the publicly deployed and the privately deployed camera systems 40.

Each camera or video recording device of the camera system 40 can be located or positioned, at its respective assigned location, to obtain or record a picture, pictures, and/or video, at or in the vicinity of its assigned location. Similarly, each microphone or audio recording device, which can be assigned to and located at the location of each camera or video recording device, can record audio information in the vicinity of its respective camera or video recording device.

Each camera system 40 can contain or include cameras and/or video recording devices which can be, or which can include, high definition cameras and/or video recording devices, wide angles lens cameras and/or video recording devices, and night vision cameras and/or video recording devices.

Each camera system 40 can communicate with the central processing computer(s) 10, the user communication devices 20, and/or any of the other computers and communication devices, and/or with any of the camera systems or mobile camera systems, described herein as being utilized in or with the apparatus 100.

In the preferred embodiment, the camera system 40 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The camera system 40 can also interface with, and/or interact with, the central processing computer 10 or with any of the other computers and communication devices, or with any of the camera systems or mobile camera systems, described herein as being used in or with the apparatus 100.

In the preferred embodiment, the camera system 40 can have a website or websites associated therewith, which can provide any of the data and/or information, described herein as being provided by the apparatus 100, the central processing computer 10, and/or the camera system 40, to any of the herein-described users, individuals, or entities who or which utilize the apparatus 100, and which can also serve as an interface for any of the users, individuals, or entities, described herein as using the apparatus 100 and methods of the present invention.

In the preferred embodiment, any number of camera systems 40 can be utilized in, or in connection with, the apparatus 100. The camera systems 40 described herein can communicate with the central processing computer(s) 10 and/or with any other computers or communication devices, or can communicate with any of the camera systems or mobile camera systems, described herein in a bi-directional manner.

With reference once again to FIG. 1, the apparatus 100 also includes any number of mobile camera systems 50. In a preferred embodiment, each mobile camera system 50 can be assigned to a moving vehicle or other moving or mobile object or entity. In this regard, for example, a mobile camera system 50, or one or more mobile camera systems 50, can be assigned to and deployed on an automobile, a law enforcement vehicle, an emergency services provider vehicle, a fire department vehicle, an ambulance, any moveable structure or moveable equipment, a passenger vehicle, a mass transportation vehicle, a bus, a train, a boat, a helicopter, an aircraft, or a drone, any of which can be manned or unmanned, or any other moving object so as to provide for obtaining a picture, picture, video, or video information, at the location of the moving object or in the vicinity of the moving object at a point in time.

In a preferred embodiment, each mobile camera system 50 can include one or more cameras or video recording devices, with each camera or video recording device being located at the vehicle or other moving or mobile object or entity. In a preferred embodiment, each mobile camera system 50 can include a single camera and/or a single video recording device or can include a plurality of cameras and/or a plurality of video recording devices. In a preferred embodiment, the mobile camera system 50 can also include a microphone or audio recording device, which can be associated with each camera and/or video recording device, for recording audio information. In a preferred embodiment, each mobile camera system 50 can also include a speaker or any number of speakers. In a preferred embodiment, the mobile camera system 50 can also be any camera and/or video recording device, which can be stationed at the respective vehicle or other moving or mobile object or entity and which can be utilized to obtain and record a respective picture, photograph, video, or video information, and to provide the respective picture, photograph, video, or video information, to the apparatus 100 and/or to the central processing computer 10 for use in connection with the apparatus 100 of the present invention.

In a preferred embodiment, the numerous mobile camera systems 50 serve to form a network of mobile camera systems 50, each of which can include a camera, cameras, a video recording device, video recording devices, a microphone, microphones, an audio recording device, audio recording devices, a speaker, and/or speakers. The network of mobile camera systems 50, when utilized along with, or in conjunction with, a number of camera systems 40, can serve to provide for a more enhanced surveillance system infrastructure.

In a preferred embodiment, each mobile camera system 50 can include a single camera or video recording device or can include a plurality of cameras or video recording devices. In a preferred embodiment, the mobile camera system 50 can also include a microphone or audio recording device for recording audio information. In a preferred embodiment, each mobile camera system 50 can also include a speaker.

Each camera or video recording device of the mobile camera system 50 can be located or positioned, to obtain or record a picture, pictures, and/or video, at or in the vicinity of vehicle, structure, or equipment, on or at which the mobile camera system 50 is assigned and located. Similarly, each microphone or audio recording device, which can be assigned to and located at the location of each camera or video recording device, can record audio information in the vicinity of its respective camera or video recording device.

Each mobile camera system 50 can contain or include cameras and/or video recording devices which can be, or which can include, high definition cameras and/or video recording devices, wide angles lens cameras and/or video recording devices, and night vision cameras and/or video recording devices.

Each mobile camera system 50 can communicate with the central processing computer(s) 10, the user communication devices 20, and/or any of the other computers and communication devices, and/or with any of the camera systems or mobile camera systems, described herein as being utilized in or with the apparatus 100.

In the preferred embodiment, the mobile camera system 50 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The mobile camera system 50 can also interface with, and/or interact with, the central processing computer 10 or with any of the other computers and communication devices, or with any of the camera systems or mobile camera systems, described herein as being used in or with the apparatus 100.

In the preferred embodiment, the mobile camera system 50 can have a website or websites associated therewith, which can provide any of the data and/or information, described herein as being provided by the apparatus 100, the central processing computer 10, and/or the mobile camera system 50, to any of the herein-described users, individuals, or entities who or which utilize the apparatus 100, and which can also serve as an interface for any of the users, individuals, or entities, described herein as using the apparatus 100 and methods of the present invention.

In the preferred embodiment, any number of mobile camera systems 50 can be utilized in, or in connection with, the apparatus 100. The mobile camera systems 50 described herein can communicate with the central processing computer(s) 10 and/or with any other computers or communication devices, or can communicate with any of the camera systems or mobile camera systems, described herein in a bi-directional manner.

In a preferred embodiment, as well as in any and/or all of the embodiments described herein, any of the camera systems 40 or the mobile camera systems 50 can be, or can include, an outdoor camera system(s) or an indoor camera system(s).

With reference to FIG. 1, the apparatus 100 also includes any number of law enforcement computers 60. The law enforcement computer 60 can be utilized by any law enforcement agency, police department, or any employee or authorized agent of same, which uses the apparatus 100 of the present invention in order to communicate with the central processing computer(s) 10 described herein, and/or to communicate with any of the other computers and communication devices, or with any of the camera systems or mobile camera systems, described herein as being utilized in or with the apparatus 100.

Each law enforcement computer 60 can communicate with the central processing computer(s) 10, the user communication devices 20, and/or any of the other computers and communication devices, and/or with any of the camera systems or mobile camera systems, described herein as being utilized in or with the apparatus 100.

In the preferred embodiment, the law enforcement computer 60 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The law enforcement computer 60 can be utilized by any of the herein-described law enforcement users in order to interface with, and/or interact with, the central processing computer 10 or with any of the other computers and communication devices, or with any of the camera systems or mobile camera systems, described herein as being used in or with the apparatus 100. In the preferred embodiment, the law enforcement computer 60 can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any law enforcement agency, police department, or any employee or authorized agent of same, which uses the apparatus 100 of the present invention. The law enforcement computer 60 can also be a server computer, a mainframe computer, a mini-computer, a microcomputer, or any other computer or device for suiting the needs of the particular user. The law enforcement computer 60 can also be a server computer, a network computer, or any other computer capable of being utilized in a network.

In the preferred embodiment, the law enforcement computer 60 can have a website or websites associated therewith, which can provide any of the data and/or information, described herein as being provided by the apparatus 100, the central processing computer 10, and/or the law enforcement computer 60, to any of the herein-described users, individuals, or entities who or which utilize the apparatus 100, and which can also serve as an interface for any of the users, individuals, or entities, described herein as using the apparatus 100 and methods of the present invention.

In the preferred embodiment, any number of law enforcement computers 60 can be utilized in, or in connection with, the apparatus 100. The law enforcement computers 60 described herein can be utilized to communicate with the central processing computer(s) 10 and/or with any other computers or communication devices, or can communicate with any of the camera systems or mobile camera systems, described herein in a bi-directional manner.

With reference to FIG. 1, the apparatus 100 also includes any number of emergency services provider computers 70. The emergency services provider computer 70 can be utilized by any emergency services provider, police department, fire department, emergency medical services provider, or ambulance service, or any employee or authorized agent of same, which uses the apparatus 100 of the present invention in order to communicate with the central processing computer(s) 10 described herein, and/or to communicate with any of the other computers and communication devices, or with any of the camera systems or mobile camera systems, described herein as being utilized in or with the apparatus 100.

Each emergency services provider computer 70 can communicate with the central processing computer(s) 10, the user communication devices 20, and/or any of the other computers and communication devices, and/or with any of the camera systems or mobile camera systems, described herein as being utilized in or with the apparatus 100.

In the preferred embodiment, the emergency services provider computer 70 can communicate with, and/or can be linked with, the central processing computer(s) 10 and/or any other computers or communication devices, or can be linked with any of the camera systems or mobile camera systems, described herein, via a wired communication network, a wireless communication network, or via any combination of wired and/or wireless communication networks.

The emergency services provider computer 70 can be utilized by any of the herein-described emergency services providers in order to interface with, and/or interact with, the central processing computer 10 or with any of the other computers and communication devices, or with any of the camera systems or mobile camera systems, described herein as being used in or with the apparatus 100. In the preferred embodiment, the emergency services provider computer 70 can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same, which can be utilized by any law enforcement agency, police department, or any employee or authorized agent of same, which uses the apparatus 100 of the present invention. The emergency services provider computer 70 can also be a server computer, a mainframe computer, a mini-computer, a microcomputer, or any other computer or device for suiting the needs of the particular user. The emergency services provider computer 70 can also be a server computer, a network computer, or any other computer capable of being utilized in a network.

In the preferred embodiment, the emergency services provider computer 70 can have a website or websites associated therewith, which can provide any of the data and/or information, described herein as being provided by the apparatus 100, the central processing computer 10, and/or the emergency services provider computer 70, to any of the herein-described users, individuals, or entities who or which utilize the apparatus 100, and which can also serve as an interface for any of the users, individuals, or entities, described herein as using the apparatus 100 and methods of the present invention.

In the preferred embodiment, any number of emergency services provider computers 70 can be utilized in, or in connection with, the apparatus 100. The emergency services provider computer 70 described herein can be utilized to communicate with the central processing computer(s) 10 and/or with any other computers or communication devices, or can communicate with any of the camera systems or mobile camera systems, described herein in a bi-directional manner.

In a preferred embodiment, any number of central processing computers 10, user communication devices 20, monitoring computers 30, camera systems 40, mobile camera systems 50, law enforcement computers 60, and emergency services provider computers 70, can be utilized in, and/or in connection with or in association with, the apparatus 100 of the present invention.

In a preferred embodiment, any of the central processing computers 10, the user communication devices 20, the monitoring computers 30, the camera systems 40, the mobile camera systems 50, the law enforcement computers 60, and/or the emergency services provider computers 70, can communicate with any other central processing computers 10, user communication devices 20, monitoring computers 30, camera systems 40, mobile camera systems 50, law enforcement computers 60, and/or emergency services provider computers 70, in a bi-directional manner. In this regard, any computer, communication device, camera system, or mobile camera system, described herein can communicate, in a bi-directional manner, with any other computer, communication device, camera system, or mobile camera system, regardless of whether the respective computer, communication device, camera system, or mobile camera system, is a central processing computer 10, a user communication device 20, a monitoring computer 30, a camera system 40, a mobile camera system 50, a law enforcement computers 60, and/or an emergency services provider computer 70.

In the preferred embodiment, the apparatus 100 and methods of the present invention is utilized on, over, or via, the Internet and/or the World Wide Web. In the preferred embodiment, the apparatus 100 and methods of the present invention can also be utilized over any suitable communication network and/or any combination of computer networks, including, but not limited to the Internet, the World Wide Web, a telecommunication network or system, a telephone network or system, a cable television communication network or system, a satellite television communication network or system, a digital television network or system, a satellite communication network or system, a broadband communication network or system, a radio frequency communication network or system, an optical communication network or system, a line-connected network or system, a wireless network or system, a radio communication network or system, a digital communication network or system, a personal communications services (PCS) network or system, a local area network (LAN), a wide area network (WAN), a wireless Internet network or system, a wireless World Wide Web network or system, an optical communication network or system, a broadband communication network or system, a Bluetooth communication network or system, a streaming video communication network or system, a streaming audio communication network or system, a live video communication network or system, and/or any other suitable communications network or system, and/or any combination(s) thereof.

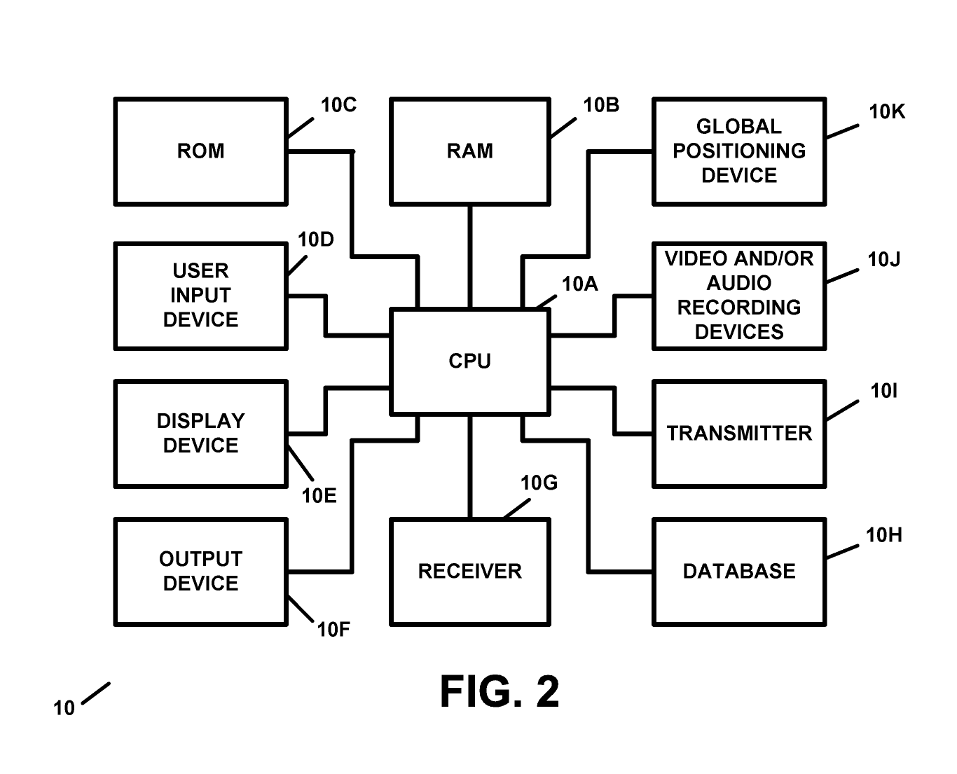

FIG. 2 illustrates the central processing computer 10 of FIG. 1, in block diagram form. With reference to FIG. 2, the central processing computer 10 includes a central processing unit (CPU) 10A. The central processing unit (CPU) 10A may be a microprocessor, a microcomputer, a minicomputer, a macro-computer, or a mainframe computer, depending upon the application. The CPU 10A is specially programmed and/or specially configured to perform all of the functionality described herein as being performed by the central processing computer 10.

The central processing computer 10 also includes a random access memory (RAM) device(s) 10B and a read only memory (ROM) device(s) 10C which are connected to the CPU 10A. The central processing computer 10 also includes a user input device(s) 10D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the central processing computer 10. The input device(s) 10D is also connected to the CPU 10A. In a preferred embodiment, data, information, instructions, or commands, can also be input by providing voice and/or audio instructions or commands via a microphone as an input device and by using voice recognition software.

The central processing computer 10 also includes a display device 10E, such as a display monitor and/or a display screen, for providing the herein-described data and/or information to the operator or user of the central processing computer 10. The display device 10E is also connected to the CPU 10A.

The central processing computer 10 can also include an output device 10F, such as a printer, a display device, a speaker, and/or a modem, for outputting, in either or both of hard copy form or electronic form, any of the data and/or information which is described herein as being provided by, from, or at, the central processing computer 10. The output device 1OF can also be connected to the CPU 10A.

The central processing computer 10 can also include a receiver 10G for receiving data and/or information, including any of the herein-described data and/or information, and/or any of the other data and/or information described herein as being provided to the central processing computer 10 from any of the user communication devices 20, from any of the monitoring computers 30, from any of the camera systems 40, from any of the mobile camera systems 50, from any of the law enforcement computers 60, from any of the emergency services provider computers 70, or from any other central processing computers 10.

The central processing computer 10 can also include a database(s) 10H, which can contain any data and/or information, and/or any software programs or software applications, which may be required, and/or which may be desired, for performing any of the functionality and/or processing routines described herein as being performed by the central processing computer 10 and/or the apparatus 100.

In a preferred embodiment, the database 10H can contain data and/or information regarding each individual, party, entity, or user, who or which uses the apparatus 100 of the present invention or any of the herein-described users or operators of any of the herein-described user communication devices 20, monitoring computers 30, camera systems 40, mobile camera systems 50, law enforcement computers 60, and/or emergency services providers computers 70.

In a preferred embodiment, the database 10H can contain and/or can include any data and/or information, any link or links and/or hyperlinks to any data and/or information, and any software programs, software algorithms, and/or software applications (“apps”), needed, required, or desired, for enabling and/or for allowing the apparatus 100 and the central processing computer 10, as well as any of the respective user communication devices 20, monitoring computers 30, camera systems 40, mobile camera systems 50, law enforcement computers 60, and/or emergency services provider computers 70, to perform all of the functionalities described-herein as being performed by the apparatus 100 of the present invention, the central processing computer 10, and/or the respective user communication devices 20, monitoring computers 30, camera systems 40, mobile camera systems 50, law enforcement computers 60, and/or emergency services provider computers 70.

The database 10H can also contain and/or include any and/or all of the data and/or information, any link or links (including hyperlinks) to any data and/or information, and any software programs, software algorithms, and/or software applications (“apps”), which can be stored on the respective databases 20H, 30H, 40H, 50H, 60H, and/or 70H, of the respective user communication devices 20, monitoring computers 30, camera systems 40, mobile camera systems 50, law enforcement computers 60, and/or emergency services provider computers 70.

In a preferred embodiment, the database(s) 10H can contain and/or can include any data and/or information regarding any individuals who are to be monitored by the apparatus 100 and any user who is using the apparatus 100 to monitor an individual. Any data and/or information regarding any individual who is to be monitored by the apparatus 100, and any data and/or information regarding any user, can include, but is not limited to, the individual's or the user's name, address, home telephone number, e-mail address, IP address, text messaging number, text messaging address, cellular telephone number, the telephone number assigned to the monitoring computer 30 in the case of an individual to be monitored or the telephone number of the user communication device 20 associated with, or used by a user, date or birth, gender, height, weight, identification photograph or picture, or any other photograph(s) or picture(s), social security number or any other suitable identification information, and/or any other data and/or information regarding the individual or the user. It is important to note that a user communication device 20 of a user can be the monitoring computer 30 for that user.

The database 10H can also contain and/or can include, for each individual being monitored by the apparatus 100, an electronic healthcare record, or a link or hyperlink to an electronic healthcare record, of the individual and/or any data and/or information regarding same or contained in same, emergency contact information for the individual, any information regarding any healthcare condition or special needs of the individual, any information regarding any medicines, prescribed medications, drugs, or prescribed drugs, which are needed by the individual, any information regarding any allergies of the individual, and/or any other information regarding any healthcare conditions, needs, or treatments, of, for, or regarding, the individual.

The database 10H can also contain and/or can include any data and/or information regarding the individual's monitoring computer 30 which can include, but which is not limited to, the type of device, such as for example, a cellular telephone, Smartphone, smartphone, personal digital assistant, or any other device described herein which can be utilized as a monitoring computer 30, the manufacturing and model number of the monitoring computer 30, a serial number of the monitoring computer 30, any other identifying data and/or information assigned to, associated with, or relating to, the monitoring computer 30, the telephone number associated with, or assigned to, the monitoring computer 30, the text messaging number associated with, or assigned to, the monitoring computer 30, the wireless or mobile telephone number associated with, or assigned to, the monitoring computer 30, an IP address associated with, or assigned to, the monitoring computer 30, an email address associated with, or assigned to the monitoring computer 30, and/or any other data and/or information associated with the monitoring computer 30. The database 10H can also contain and/or can include any of the above-described information for any other monitoring computer 30 or any number of monitoring computers 30 which is/are used by the individual.

The database 10H can also contain and/or can include any data and/or information regarding the user's user communication device 20 which can include, but which is not limited to, the type of device, such as for example, a cellular telephone, Smartphone, smartphone, personal digital assistant, or any other device described herein which can be utilized as a user communication device 20, the manufacturing and model number of the user communication device 20, a serial number of the user communication device 20, any other identifying data and/or information assigned to, associated with, or relating to, the user communication device 20, the telephone number associated with, or assigned to, the user communication device 20, the text messaging number associated with, or assigned to, the user communication device 20, the wireless or mobile telephone number associated with, or assigned to, the user communication device 20, an IP address associated with, or assigned to, user communication device 20, an email address associated with, or assigned to the user communication device 20, and/or any other data and/or information associated with the user communication device 20. The database 10H can also contain and/or can include any of the above-described information for any other user communication device 20 or any number of user communication devices 20 which is/are used by the user.

The database 10H can also contain and/or can include any data and/or information regarding a user who is monitoring the individual being monitored. In a preferred embodiment, the user who is monitoring, or who is or will be responsible for monitoring, the individual can be, but is not limited to being, the individual's parent or parents, spouse, sibling, relative, friend, nanny, au pair, caregiver, teacher, employer, or any other person or entity, who or which is monitoring the individual. For each user and, therefore, for each respective parent, spouse, sibling, relative, friend, nanny, au pair, caregiver, teacher, employer, or any other person or entity, who monitors the individual, the database 10H can contain and/or can include any data and/or information regarding the name, address, telephone number, cellular telephone number, user communication device telephone number or cellular telephone number, e-mail address, text messaging number, and/or any other data and/or information, and/or contact information, of, for, or regarding, the user. The database 10H can also contain and/or can include any other data and/or information, described herein as being stored for or regarding the user.

The database 10H can also contain and/or can include any data and/or information regarding places, locations, or venues, where the individual may work, go to school, or engage in any other activities. The database 10H can also contain and/or can include any data and/or information regarding any travel routs on which the individual may travel.

In a preferred embodiment, the database(s) 10H can contain and/or can include any data and/or information regarding any vehicles or moving or mobile objects or entities which are to be monitored by the apparatus 100 and any user who is using the apparatus 100 to monitor a vehicle or moving or mobile object. Any data and/or information regarding any vehicle or moving or mobile object which is to be monitored by the apparatus 100, and any data and/or information regarding any user assigned to monitor same, can include, but is not limited to, the vehicle's or the moving or mobile object's name, registered owner, registered address, registered home telephone number, registered e-mail address, registered IP address, registered text messaging number, registered text messaging address, registered cellular telephone number, registered telephone number assigned to the monitoring computer 30 assigned to the vehicle or moving or mobile object or the telephone number of the user communication device 20 associated with, or used by a user who is monitoring the vehicle or the moving or mobile object, information regarding a description of, the manufacture, model, model name, and/or model year, and/or a picture or photograph, of or for the vehicle or the moving or mobile object, registration number of identification number of or for the vehicle or the moving or mobile object, and/or any other data and/or information regarding the vehicle or the moving or mobile object or the user who is to be monitoring same.

The database 10H can also contain and/or can include any data and/or information regarding the vehicle's or the moving or mobile object's monitoring computer 30 which can include, but which is not limited to, the type of device, such as for example, a cellular telephone, Smartphone, smartphone, personal digital assistant, or any other device described herein which can be utilized as a monitoring computer 30, the manufacturing and model number of the monitoring computer 30, a serial number of the monitoring computer 30, any other identifying data and/or information assigned to, associated with, or relating to, the monitoring computer 30, the telephone number associated with, or assigned to, the monitoring computer 30, the text messaging number associated with, or assigned to, the monitoring computer 30, the wireless or mobile telephone number associated with, or assigned to, the monitoring computer 30, an IP address associated with, or assigned to, the monitoring computer 30 and/or to the vehicle or the moving or mobile object, an email address associated with, or assigned to the monitoring computer 30, and/or any other data and/or information associated with the monitoring computer 30. The database 10H can also contain and/or can include any of the above-described information for any other monitoring computer 30 or any number of monitoring computers 30 which is/are used by the vehicle or the moving or mobile object.

For the user or user's assigned to monitor the vehicle or the moving or mobile object, the database 10H can also contain and/or can include any data and/or information regarding the user's user communication device 20 which can include, but which is not limited to, the type of device, such as for example, a cellular telephone, Smartphone, smartphone, personal digital assistant, or any other device described herein which can be utilized as a user communication device 20, the manufacturing and model number of the user communication device 20, a serial number of the user communication device 20, any other identifying data and/or information assigned to, associated with, or relating to, the user communication device 20, the telephone number associated with, or assigned to, the user communication device 20, the text messaging number associated with, or assigned to, the user communication device 20, the wireless or mobile telephone number associated with, or assigned to, the user communication device 20, an IP address associated with, or assigned to, user communication device 20, an email address associated with, or assigned to the user communication device 20, and/or any other data and/or information associated with the user communication device 20. The database 10H can also contain and/or can include any of the above-described information for any other user communication device 20 or any number of user communication devices 20 which is/are used by the use or other individual.

In a preferred embodiment, the database(s) 10H can contain and/or can include any data and/or information regarding any articles or objects which are to be monitored by the apparatus 100 and any user who is using the apparatus 100 to monitor an article or an object. Any data and/or information regarding any article or object which is to be monitored by the apparatus 100, and any data and/or information regarding any user assigned to monitor same, can include, but is not limited to, the article's or the object's name, registered owner, registered address, registered home telephone number, registered e-mail address, registered IP address, registered text messaging number, registered text messaging address, registered cellular telephone number, registered telephone number assigned to the monitoring computer 30 assigned to the article or object or the telephone number of the user communication device 20 associated with, or used by a user who is monitoring the article or the object, information regarding a description of, the manufacturer, model, model name, and/or model year, and/or a picture or photograph, of or for the article or the object, registration number of identification number of or for the article or the object, and/or any other data and/or information regarding the article or the object or the user who is to be monitoring same.

The database 10H can also contain and/or can include any data and/or information regarding the article's or the object's monitoring computer 30 which can include, but which is not limited to, the type of device, such as for example, a cellular telephone, Smartphone, smartphone, personal digital assistant, or any other device described herein which can be utilized as a monitoring computer 30, the manufacturing and model number of the monitoring computer 30, a serial number of the monitoring computer 30, any other identifying data and/or information assigned to, associated with, or relating to, the monitoring computer 30, the telephone number associated with, or assigned to, the monitoring computer 30, the text messaging number associated with, or assigned to, the monitoring computer 30, the wireless or mobile telephone number associated with, or assigned to, the monitoring computer 30, an IP address associated with, or assigned to, the monitoring computer 30 and/or to the article or the object, an email address associated with, or assigned to the monitoring computer 30, and/or any other data and/or information associated with the monitoring computer 30. The database 10H can also contain and/or can include any of the above-described information for any other monitoring computer 30 or any number of monitoring computers 30 which is/are used by the article or the object.

For the user or user's assigned to monitor the article or the object, the database 10H can also contain and/or can include any data and/or information regarding the user's user communication device 20 which can include, but which is not limited to, the type of device, such as for example, a cellular telephone, Smartphone, smartphone, personal digital assistant, or any other device described herein which can be utilized as a user communication device 20, the manufacturing and model number of the user communication device 20, a serial number of the user communication device 20, any other identifying data and/or information assigned to, associated with, or relating to, the user communication device 20, the telephone number associated with, or assigned to, the user communication device 20, the text messaging number associated with, or assigned to, the user communication device 20, the wireless or mobile telephone number associated with, or assigned to, the user communication device 20, an IP address associated with, or assigned to, user communication device 20, an email address associated with, or assigned to the user communication device 20, and/or any other data and/or information associated with the user communication device 20. The database 10H can also contain and/or can include any of the above-described information for any other user communication device 20 or any number of user communication devices 20 which is/are used by the individual.

The database 10H can also contain and/or can include any data and/or information regarding a user who is monitoring a vehicle, a moving or mobile object, an article, or an object. In a preferred embodiment, the user who is monitoring the vehicle, moving or mobile object, article, or object, can be, but is not limited to being, the owner, operator, or person assigned to monitor, the vehicle, moving or mobile object, article, or object. For each user who or which monitors a vehicle, moving or mobile object, article, or object, the database 10H can contain and/or can include any data and/or information regarding the name, address, telephone number, cellular telephone number, user communication device telephone number or cellular telephone number, e-mail address, text messaging number, and/or any other data and/or information, and/or contact information, of, for, or regarding, the user. The database 10H can also contain and/or can include any other data and/or information, described herein as being stored for or regarding the user.

The database 10H can also contain and/or can include any data and/or information regarding places, locations, and/or venues, where the vehicle, moving or mobile object, article, or object, can be expected to be located or to travel to, as well as any travel routes on which the vehicle, moving or mobile object, article, or object, may travel to same.

The database 10H can also contain and/or include digital map data for any geographical areas and/or regions in which the apparatus 100 can or may be operated. Any and/or all digital map data can include information regarding all properties, public roads and/or roadways of all types or kinds, property addresses, buildings, structures, points of interest, and/or any other information which can be found in an commercially available navigation products and/or services. The database 10H can also contain and/or include any navigation software programs, navigation algorithms, and/or navigation software applications and/or apps, or any links or hyperlinks to same, for determining navigations routes and/or travel routes and/or expected navigation and/or travel routes.

The database 10H can also contain and/or include, for any and/or all camera systems 40 utilized by the apparatus 100, any and/or all data and/or information regarding the camera system 40, including, but not limited to, information regarding the identification of the camera system 40, the owner or operator of the camera system, the location or position of the camera system 40 and/or the location or position of any and/or all cameras, video recording devices, microphones, audio recording devices, speakers, indicators, display monitors, display screens, and/or speakers, of or associated with the camera system 40, information regarding any manufacturers, model names, model numbers, and/or any other information regarding and and/or all cameras, video recording devices, microphones, audio recording devices, speakers, indicators, display monitors, display screens, and/or speakers, of or associated with the camera system 40, and/or any and/or all data and/or information obtained by and/or recorded by the camera system 40.

The database 10H can also contain data and/or information regarding any website or websites, domain name(s), uniform resource locators (urls), IP addresses, and/or any link(s) or hyperlink(s), of, for, or associated with, each camera system 40 and/or for each camera, video recording device, microphone, audio recording device, speaker, indicator, display monitor, display screen, and/or speaker, and/or any other component of, the camera system 40.

The database 10H can also contain and/or include any data and/or information needed for allowing for the remote access, control, and/or monitoring, of the camera system 40 by any one or more of the apparatus 100, the central processing computer 10, and/or any of the user communication devices 20, monitoring computers 30, law enforcement computers 60, and/or emergency services provider computers 70, described herein, as well as by any other camera systems 40 or mobile camera systems 50 described herein.

The database 10H can also contain and/or include, for any and/or all mobile camera systems 50 utilized by the apparatus 100, any and/or all data and/or information regarding the mobile camera system 50, including, but not limited to, information regarding the identification of the mobile camera system 50, the owner or operator of the camera system, the vehicle or moving or mobile object or entity on or at which the mobile camera system 50 is deployed or associated, knows or past known locations, positions, or areas of travel of, the mobile camera system 50, any and/or all cameras, video recording devices, microphones, audio recording devices, speakers, indicators, display monitors, display screens, and/or speakers, of, deployed on or at, or associated with, the mobile camera system 50, information regarding any manufacturers, model names, model numbers, and/or any other information regarding the vehicle or moving or mobile object or entity of, and and/or any and/or all cameras, video recording devices, microphones, audio recording devices, speakers, indicators, display monitors, display screens, and/or speakers, of or associated with the mobile camera system 50, and/or any and/or all data and/or information obtained by and/or recorded by the mobile camera system 50.

The database 10H can also contain data and/or information regarding any website or websites, domain name(s), uniform resource locators (urls), IP addresses, and/or any link(s) or hyperlink(s), of, for, or associated with, each mobile camera system 50 and/or for each camera, video recording device, microphone, audio recording device, speaker, indicator, display monitor, display screen, and/or speaker, and/or any other component of, the mobile camera system 50.

The database 10H can also contain and/or include any data and/or information needed for allowing for the remote access, control, and/or monitoring, of the mobile camera system 50 by any one or more of the apparatus 100, the central processing computer 10, and/or any of the user communication devices 20, monitoring computers 30, law enforcement computers 60, and/or emergency services provider computers 70, described herein, as well as by any other camera systems 40 or mobile camera systems 50 described herein.

The database 10H can also contain and/or can include navigation software for allowing the central processing computer 10, the user communication devices 20, the monitoring computers 30, the camera systems 40, the mobile camera systems 50, the law enforcement computers 60, and/or the emergency services providers computers 70, to calculate, ascertain, or determine, travel routes, to detect departures from a travel route, to re-calculate a new travel route, for individuals being monitored by the apparatus 100.

The database 10H can also contain and/or include pre-recorded video messages and/or audio message(s) which can be displayed or played via any of the indicators, display monitors, display screens, and/or speakers, of or associated with any of the camera systems 40 and/or mobile camera systems 50 described herein.

The database(s) 10H can also contain and/or can include, for each law enforcement agency and for each emergency services provider which utilizes the apparatus 100, data and/or information regarding the name, address, telephone number, e-mail address, website address, url, text messaging number, text messaging address, cellular telephone number, and/or any other contact information for the respective law enforcement agency or emergency services provider. The database 10H can also contain and/or include data and/or information regarding each law enforcement agency and/or each emergency services provider including, but not limited to, the geographical area(s), municipality or municipalities, city or cities, state or states, province or provinces, or county or countries, in which it operates, covers, or has jurisdiction, as well as the various services it provides or is authorized to provide. The database 10H can also contain and/or include information regarding the website address, domain name(s), IP addresses, and/or any other data and/or information regarding any law enforcement computer(s) 60 or emergency services provider computer(s) 70 of, associated with, or operated by, a respective law enforcement agency or emergency services provider.

The database 10H can also contain data and/or information regarding any website or websites, domain name(s), uniform resource locators (urls), IP addresses, and/or any link(s) or hyperlink(s), of, for, or associated with, the apparatus 100, the central processing computer 10, and/or any of the user communication devices 20, the monitoring computers 30, the camera systems 40, the mobile camera systems 50, the law enforcement computers 60, and/or the emergency services provider computers 70, described herein as being utilized by or with the apparatus 100.

The database 10H can also contain and/or can include any data, information, software, software programs, algorithms, and/or software applications (or “apps”) which are needed or desired for allowing the apparatus 100 and/or the central processing computer 10 to perform any and/or all of the functions and/or functionalities described herein as being capable of being performed by the apparatus 100 and methods of the present invention.

The database 10H can also contain and/or include any data and/or information, reports, messages, activity reports, pictures, photographs, video information, video clips, video recordings, audio information, audio clips, and/or audio recordings, and/or any other data and/or information, described herein as being processed by, provided by, or utilized by, the apparatus 100, the central processing computer 10, the user communication devices 20, the monitoring computers 30, the camera systems 40, the mobile camera systems 50, the law enforcement computers 60, and/or the emergency services provider computers 70, described herein.

The database 10H can also contain and/or can include any of the data and/or information described herein as being stored in any of other databases 20H, 30H, 40H, 50H, and/or 60H, described herein.

In a preferred embodiment, the database 10H can contain and/or can include any and/or all data and/or information, as well as any and/or all software programs, software algorithms, and/or software applications or “apps”, needed, required, or desired, for enabling the apparatus 100, and each of the central processing computer 10, the user communication devices 20, the monitoring computers 30, the camera systems 40, the mobile camera systems 50, the law enforcement computers 60, and/or the emergency services provider computers 70, to perform any and/or all of the various functions and functionalities described herein as capable of being performed by apparatus 100, the central processing computer 10, the user communication devices 20, the monitoring computers 30, the camera systems 40, the mobile camera systems 50, the law enforcement computers 60, and/or the emergency services provider computers 70.

The central processing computer 10 can also include a transmitter 10I for transmitting data and/or information, including any of the herein-described data and/or information, and/or any other data and/or information described herein as being provided by, from, or to, the central processing computer 10, to any of the user communication devices 20, any of the monitoring computers 30, any of the camera systems 40, any of the mobile camera systems 50, any of the law enforcement computers 60, any of the emergency services provider computers 70, or any of the other central processing computers 10. The transmitter 10I can also be connected to the CPU 10A.

With reference once again to FIG. 2, the central processing computer 10 can also include a video and/or audio recording device(s) 10J which can include a camera and/or a video recording device for recording pictures or video and/or video clips and/or a microphone or an audio recording device for recording audio or audio clips which can be recorded by, and/or transmitted live, by or from the central processing computer 10, or which can be recorded by, and stored at or in, the central processing computer 10 for transmission by or from the central processing computer 10 at a later time. The video and/or audio recording device(s) 10J can also be utilized to facilitate one-way broadcasts from the central processing computer 10, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the central processing computer 10 can engage in telephone calls, video telephone calls, and/or video conferencing calls, via the same. The user or operator of the central processing computer 10 can also use the video and/or audio recording device(s) 10J to record and broadcast or transmit content via the transmitter 10I.

With reference once again to FIG. 2, the central processing computer 10 can also include a global positioning device 10K for determining the position or location of the central processing computer 10. In a preferred embodiment, the global positioning device 10K can be utilized in order to determine or ascertain the position or location of the central processing computer 10 at any time and/or for any reason or purpose.

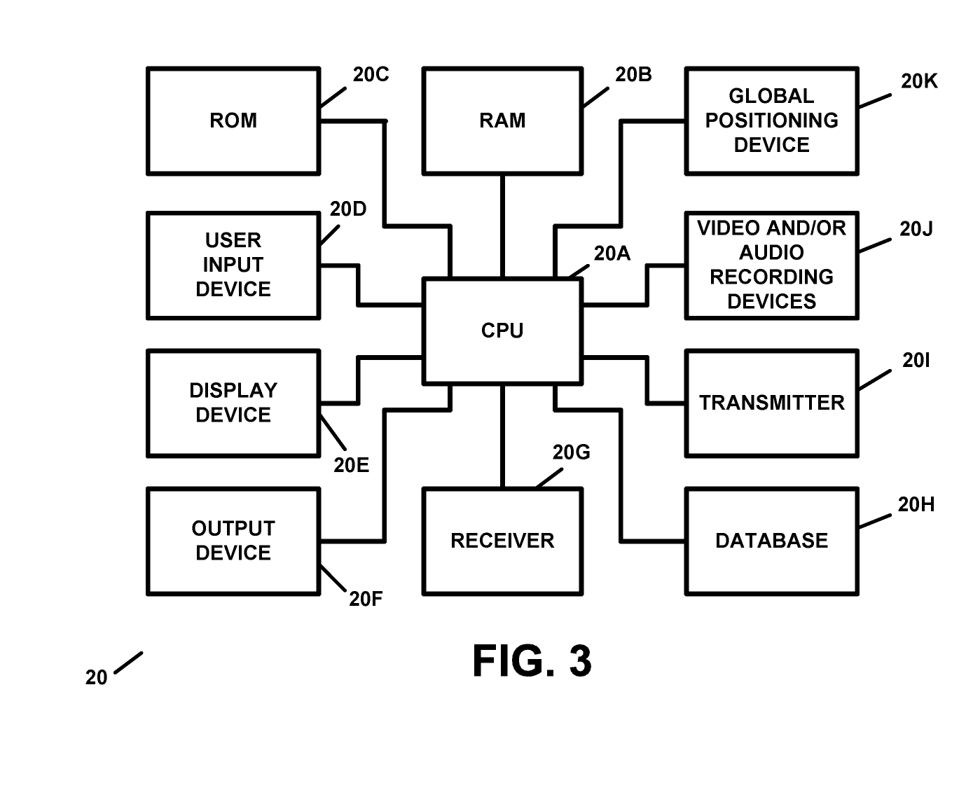

FIG. 3 illustrates the user communication device 20 of FIG. 1, in block diagram form. In a preferred embodiment, the user communication device 20 can be, or can include, any communication device, a computer, a computer terminal, a terminal device connected to, or associated with, the central processing computer 10, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same, or any equivalent of same.

With reference to FIG. 3, the user communication device 20 includes a central processing unit (CPU) 20A. The central processing unit (CPU) 20A may be a microprocessor, a microcomputer, a minicomputer, a macro-computer, or a mainframe computer, depending upon the application. The CPU 20A is specially programmed and/or specially configured to perform all of the functionality described herein as being performed by the user communication device 20.

The user communication device 20 also includes a random access memory (RAM) device(s) 20B and a read only memory (ROM) device(s) 20C which are connected to the CPU 20A. The user communication device 20 also includes a user input device(s) 20D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the user communication device 20. The input device(s) 20D is also connected to the CPU 20A. In a preferred embodiment, data, information, instructions, or commands, can also be input by providing voice and/or audio instructions or commands via a microphone as an input device and by using voice recognition software.

The user communication device 20 also includes a display device 20E, such as a display monitor and/or a display screen, for providing the herein-described data and/or information to the user of the user communication device 20. The display device 20E is also connected to the CPU 20A.

The user communication device 20 can also include an output device 20F, such as a printer, a display device, a speaker, and/or a modem, for outputting, in either or both of hard copy form or electronic form, any of the data and/or information which is described herein as being provided by, from, or at, the user communication device 20. The output device 20F can also be connected to the CPU 20A.

The user communication device 20 can also include a receiver 20G for receiving data and/or information, including any of the herein-described data and/or information, and/or any of the other data and/or information described herein as being provided to the user communication device 20 from any of the central processing computers 10, from any of the monitoring computers 30, from any of the camera systems 40, from any of the mobile camera systems 50, from any of the law enforcement computers 60, from any of the emergency services provider computers 70, or from any other user communication devices 20.

The user communication device 20 can also include a database(s) 20H, which can contain any data and/or information, and/or any software programs or software applications, which may be required, and/or which may be desired, for performing any of the functionality and/or processing routines described herein as being performed by the user communication device 20 and/or the apparatus 100.

In a preferred embodiment, the database 20H can contain data and/or information regarding each individual, party, entity, or user, who or which uses the apparatus 100 of the present invention or any of the herein-described users or operators of any of the herein-described user communication devices 20, monitoring computers 30, camera systems 40, mobile camera systems 50, law enforcement computers 60, and/or emergency services providers computers 70.

In a preferred embodiment, the database 20H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the user communication device 20 to perform any and/or all of the various functions and functionalities described herein as being performed by the user communication device 20. The database 20H can also contain and/or can include any of the data and/or information regarding the user communication device 20, as well as any data and/or information regarding the user or users of the user communication device 20, described herein as being stored in the database 10H of the central processing computer 10 or otherwise.

The database 20H can also contain and/or can include any data, information, reports, messages, activity reports, or any other data and/or information described herein as be used by, processed by, transmitted from, and/or received by, the user communication device 20 in performing any and/or of the functions or functionalities described herein as being performed by the user communication device 20. The database 20H can also contain and/or can include any data and/or information, as well as any and/or all software programs, software algorithms, and/or software applications or “apps”, needed, required, or desired, for enabling and allowing the user communication device 20 to perform any and/or all of the functions or functionalities described herein as being performed by the user communication device 20.

The user communication device 20 can also include a transmitter 201 for transmitting data and/or information, including any of the herein-described data and/or information, and/or any other data and/or information described herein as being provided by, from, or to, the user communication device 20, to any of the central processing computers, any of the monitoring computers 30, any of the camera systems 40, any of the mobile camera systems 50, any of the law enforcement computers 60, any of the emergency services provider computers 70, or any other user communication devices 20. The transmitter 201 can also be connected to the CPU 20A.

With reference once again to FIG. 3, the user communication device 20 can also include a video and/or audio recording device(s) 20J which can include one or more cameras and/or video recording devices for recording pictures or video and/or video clips and/or a microphone or an audio recording device for recording audio or audio clips which can be recorded by, and/or transmitted live, by or from the user communication device 20, or which can be recorded by, and stored at or in, the user communication device 20 for transmission by or from the user communication device 20 at a later time. The video and/or audio recording device(s) 20J can also be utilized to facilitate one-way broadcasts from the user communication device 20, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the user communication device 20 can engage in telephone calls, video telephone calls, and/or video conferencing calls, via the same. The user of the user communication device 20 can also use the video and/or audio recording device(s) 20J to record and broadcast or transmit content via the transmitter 201.

With reference once again to FIG. 3, the user communication device 20 can also include a global positioning device 20K for determining the position or location of the user communication device 20. In a preferred embodiment, the global positioning device 20K can be utilized in order to determine or ascertain the position or location of the user communication device 20 at any time and/or for any reason or purpose.

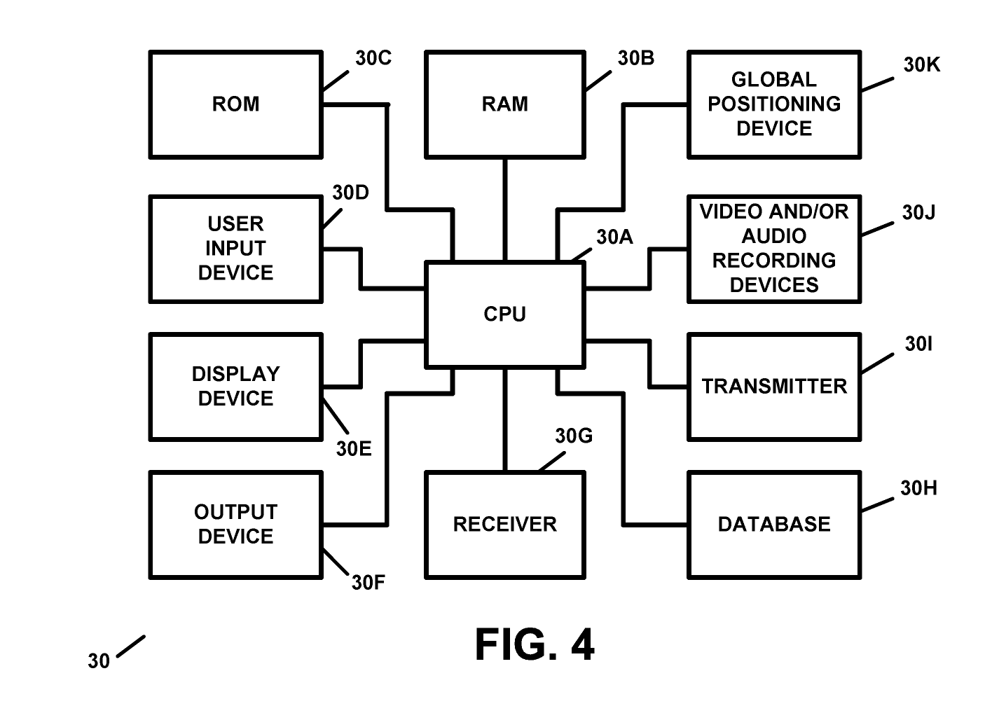

FIG. 4 illustrates the monitoring computer 30 of FIG. 1, in block diagram form. In a preferred embodiment, the monitoring computer 30 can be, or can include, any communication device, a computer, a personal computer, a home computer, a laptop computer, a notebook computer, a tablet, a tablet computer, a personal communication device, a smart phone or Smartphone, a cellular telephone, a wireless telephone, a videophone, a video telephone, a personal digital assistant, a beeper or a pager, a watch, an article or item of jewelry, a smart watch, a wearable device or computer, eyeglasses, or any accessory, equipped with communications equipment, an implantable device or computer, or any combination of same, or any equivalent of same, which can be utilized to monitor any individual, vehicle, or article or object, with or using the apparatus 100 and methods of the present invention.

With reference to FIG. 4, the monitoring computer 30 includes a central processing unit (CPU) 30A. The central processing unit (CPU) 30A may be a microprocessor, a microcomputer, a minicomputer, a macro-computer, or a mainframe computer, depending upon the application. The CPU 30A is specially programmed and/or specially configured to perform all of the functionality described herein as being performed by the monitoring computer 30.

The monitoring computer 30 also includes a random access memory (RAM) device(s) 30B and a read only memory (ROM) device(s) 30C which are connected to the CPU 30A. The monitoring computer 30 also includes a user input device(s) 30D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the monitoring computer 30. The input device(s) 30D is also connected to the CPU 30A. In a preferred embodiment, data, information, instructions, or commands, can also be input by providing voice and/or audio instructions or commands via a microphone as an input device and by using voice recognition software.

The monitoring computer 30 also includes a display device 30E, such as a display monitor and/or a display screen, for providing the herein-described data and/or information to the user of the monitoring computer 30. The display device 30E is also connected to the CPU 30A.

The monitoring computer 30 can also include an output device 30F, such as a printer, a display device, a speaker, and/or a modem, for outputting, in either or both of hard copy form or electronic form, any of the data and/or information which is described herein as being provided by, from, or at, the monitoring computer 30. The output device 30F can also be connected to the CPU 30A.

The monitoring computer 30 can also include a receiver 30G for receiving data and/or information, including any of the herein-described data and/or information, and/or any of the other data and/or information described herein as being provided to the monitoring computer 30 from any of the central processing computers 10, from any of the user communication devices 20, from any of the camera systems 40, from any of the mobile camera systems 50, from any of the law enforcement computers 60, from any of the emergency services provider computers 70, or from any other monitoring computers 30.

The monitoring computer 30 can also include a database(s) 30H, which can contain any data and/or information, and/or any software programs or software applications, which may be required, and/or which may be desired, for performing any of the functionality and/or processing routines described herein as being performed by the monitoring computer 30 and/or the apparatus 100.

In a preferred embodiment, the database 30H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the monitoring computer 30 to perform any and/or all of the various functions and functionalities described herein as being performed by the monitoring computer 30. The database 30H can also contain and/or can include any of the data and/or information regarding the monitoring computer 30, as well as any data and/or information regarding the individual using the monitoring computer 30, described herein as being stored in the database 10H of the central processing computer 10 or otherwise.

The database 30H can also contain and/or can include any data, information, reports, messages, activity reports, or any other data and/or information described herein as be used by, processed by, transmitted from, and/or received by, the monitoring computer 30 in performing any and/or of the functions or functionalities described herein as being performed by the monitoring computer 30. The database 30H can also contain and/or can include any data and/or information, as well as any and/or all software programs, software algorithms, and/or software applications or “apps”, needed, required, or desired, for enabling and allowing the monitoring computer 30 to perform any and/or all of the functions or functionalities described herein as being performed by the monitoring computer 30.

The monitoring computer 30 can also include a transmitter 30I for transmitting data and/or information, including any of the herein-described data and/or information, and/or any other data and/or information described herein as being provided by, from, or to, the monitoring computer 30, to any of the central processing computers, any of the user communication devices 20, any of the camera systems 40, any of the mobile camera systems 50, any of the law enforcement computers 60, any of the emergency services provider computers 70, or any other monitoring computers 30. The transmitter 30I can also be connected to the CPU 30A.

With reference once again to FIG. 4, the monitoring computer 30 can also include a video and/or audio recording device(s) 30J which can include one or more cameras and/or video recording devices for recording pictures or video and/or video clips and/or a microphone or an audio recording device for recording audio or audio clips which can be recorded by, and/or transmitted live, by or from the monitoring computer 30, or which can be recorded by, and stored at or in, the monitoring computer 30 for transmission by or from the monitoring computer 30 at a later time. The video and/or audio recording device(s) 30J can also be utilized to facilitate one-way broadcasts from the monitoring computer 30, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user of the monitoring computer 30 can engage in telephone calls, video telephone calls, and/or video conference calls, via the same. The user of the monitoring computer 30 can also use the video and/or audio recording device(s) 30J to record and broadcast or transmit content via the transmitter 30I.

With reference once again to FIG. 4, the monitoring computer 30 can also include a global positioning device 30K for determining the position or location of the monitoring computer 30. In a preferred embodiment, the global positioning device 30K can be utilized in order to determine or ascertain the position or location of the monitoring computer 30 at any time and/or for any reason or purpose.

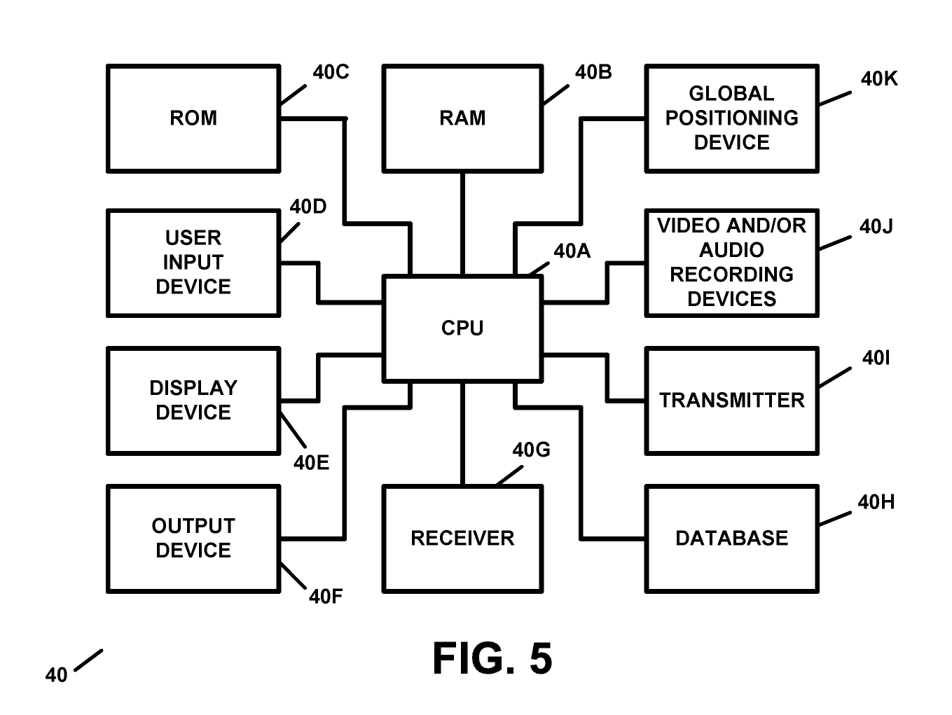

FIG. 5 illustrates the camera system 40 of FIG. 1, in block diagram form. In a preferred embodiment, each camera system 40 can include one or more cameras or video recording devices, with each camera or video recording device being located at a known location or address. In a preferred embodiment, each camera system 40 can include a single camera and/or a single video recording device or can include a plurality of cameras and/or a plurality of video recording devices. In a preferred embodiment, the camera system 40 can also include a microphone or audio recording device, which can be associated with each camera and/or video recording device, for recording audio information. In a preferred embodiment, each camera system 40 can also include a speaker or any number of speakers. In a preferred embodiment the camera system 40 can also simply be any camera and/or video recording device, which can be stationed at a fixed location, or at a number of locations, and which can be utilized to obtain and record a respective picture, photograph, video, or video information, and to provide the respective picture, photograph, video, or video information, to the apparatus 100 and/or to the central processing computer 10 for use in connection with the apparatus 100 of the present invention.

With reference to FIG. 5, the camera system 40 can include a central processing unit (CPU) 40A. The central processing unit (CPU) 40A may be a microprocessor, a microcomputer, a minicomputer, a macro-computer, or a mainframe computer, depending upon the application. The CPU 40A is specially programmed and/or specially configured to perform all of the functionality described herein as being performed by the camera system 40.

The camera system 40 can also include a random access memory (RAM) device(s) 40B and a read only memory (ROM) device(s) 40C which can be connected to the CPU 40A. The camera system 40 can also include a user input device(s) 40D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the camera system 40. The input device(s) 40D can be connected to the CPU 40A. In a preferred embodiment, data, information, instructions, or commands, can also be input by providing voice and/or audio instructions or commands via a microphone as an input device and by using voice recognition software.

The camera system 40 can also include a display device 40E, such as a display monitor and/or a display screen, for providing the herein-described data and/or information to the user of the camera system 40. The display device 40E can also include an external display device, an indicator light, an outdoor display screen, and/or a speaker or public address system, which can be located indoors or outdoors and/or adjacent to the camera system 40 so as to provide for the public display or dissemination of a signal, an indication, or a message, from the apparatus 100. For example, a color (for example, red) can be illuminated via the indicator light to signal that a person, of any age, is missing in the area, or a message can be provided via the outdoor display screen to broadcast a message, in any appropriate manner, to provide an alert that a person is missing in the area or in need of assistance, along with a description and/or a picture or photograph of the person, or a message can be played via or over the speaker or the public address system so as to provide a broadcast of information regarding the person and the situation to those persons present in the vicinity of the camera system 40. The display device 40E can also be connected to the CPU 40A.

The camera system 40 can also include an output device 40F, such as a printer, a display device, a speaker, and/or a modem, for outputting, in either or both of hard copy form or electronic form, any of the data and/or information which is described herein as being provided by, from, or at, the camera system 40. The output device 40F can also include an external display device, indicator light, an outdoor display screen, or a speaker or public address system, which can be located indoors or outdoors and/or adjacent to the camera system 40 so as to provide for the public display of a signal, an indication, or a message from the apparatus 100. As noted above, a color (for example, red) can be illuminated via the indicator light to signal that a person, of any age, is missing in the area, or a message can be provided via the outdoor display screen to broadcast a message, in any appropriate manner, to provide an alert that a person is missing in the area or in need of assistance, along with a description and/or a picture or photograph of the person, or a message can be played via or over the speaker or the public address system so as to provide a broadcast of information regarding the person and the situation to those persons present in the vicinity of the camera system 40. The output device 40F can also be connected to the CPU 40A.

The camera system 40 can also include a receiver 40G for receiving data and/or information, including any of the herein-described data and/or information, and/or any of the other data and/or information described herein as being provided to the camera system 40 from any of the central processing computers 10, from any of the user communication devices 20, from any of the monitoring computers 30, from any of the mobile camera systems 50, from any of the law enforcement computers 60, from any of the emergency services provider computers 70, or from any other camera systems 40.

The camera system 40 can also include a database(s) 40H, which can contain any data and/or information, and/or any software programs or software applications, which may be required, and/or which may be desired, for performing any of the functionality and/or processing routines described herein as being performed by the camera system 40 and/or the apparatus 100.

In a preferred embodiment, the database 40H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the camera system 40 to perform any and/or all of the various functions and functionalities described herein as being performed by the camera system 40. The database 40H can also contain and/or can include any of the data and/or information regarding the camera system 40, as well as any data and/or information regarding the owner(s) or operator(s) of the camera system 40, described herein as being stored in the database 10H of the central processing computer 10 or otherwise.

The database 40H can also contain and/or can include any data, information, reports, messages, activity reports, or any other data and/or information described herein as be used by, processed by, transmitted from, and/or received by, the camera system 40 in performing any and/or of the functions or functionalities described herein as being performed by the camera system 40. The database 40H can also contain and/or can include any data and/or information, as well as any and/or all software programs, software algorithms, and/or software applications or “apps”, needed, required, or desired, for enabling and allowing the camera system 40 to perform any and/or all of the functions or functionalities described herein as being performed by the camera system 40.

The camera system 40 can also include a transmitter 401 for transmitting data and/or information, including any of the herein-described data and/or information, and/or any other data and/or information described herein as being provided by, from, or to, the camera system 40, to any of the central processing computers 10, any of the user communication devices 20, any of the monitoring computers 30, any of the mobile camera systems 50, any of the law enforcement computers 60, any of the emergency services provider computers 70, or any other camera systems 40. The transmitter 401 can also be connected to the CPU 40A.

With reference once again to FIG. 5, the camera system 50 can also include a video and/or audio recording device(s) 40J which can include one or more cameras and/or one or more video recording devices for recording pictures, photographs, videos, video information, and/or video clips, and/or one or more microphones or one or more audio recording devices for recording audio or audio clips, which can be recorded by, and/or transmitted live, by or from the camera system 40, or which can be recorded by, and stored at or in, the camera system 40 for transmission by or from the camera system 40 at a later time. In a preferred embodiment, a microphone or an audio recording device can be associated with each camera or video recoding device of the camera system 40. In another preferred embodiment, a single microphone or audio recording device can be associated with the camera system 40. In a preferred embodiment, a separate and additional video and/or audio recording device(s) 40J can also be utilized to facilitate one-way broadcasts from the camera system 40 by a user or operator of same, and/or can be utilized to facilitate video conferencing, video chatting, and/or audio conferencing, and/or video and audio conferencing, between any of the herein-described users, individuals, parties, or entities, who or which utilize the apparatus 100 and method of the present invention, and a user or operator of the camera system 40. In this regard, the user or operator of the camera system 40 can engage in telephone calls, video telephone calls, and/or video conference calls, via the same. The user or operator of the camera system 40 can also use the video and/or audio recording device(s) 40J to record and broadcast or transmit content via the transmitter 401.

With reference once again to FIG. 5, the camera system 40 can also include a global positioning device 40K for determining the position or location of the camera system 40. In a preferred embodiment, the global positioning device 40K can be utilized in order to determine or ascertain the position or location of the camera system 40 at any time and/or for any reason or purpose.

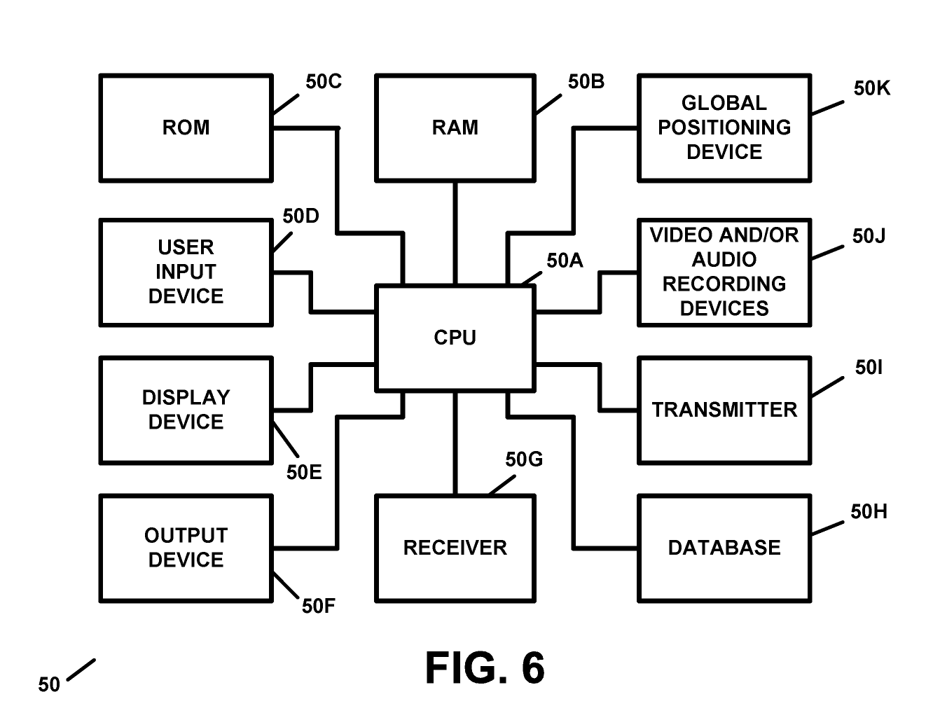

FIG. 6 illustrates the mobile camera system 50 of FIG. 1, in block diagram form. In a preferred embodiment, each mobile camera system 50 can include one or more cameras or video recording devices, with each camera or video recording device being located at the vehicle or moving or mobile object or entity. In a preferred embodiment, each mobile camera system 50 can include a single camera and/or a single video recording device or can include a plurality of cameras and/or a plurality of video recording devices. In a preferred embodiment, the mobile camera system 50 can also include a microphone or audio recording device, which can be associated with each camera and/or video recording device, for recording audio information. In a preferred embodiment, each mobile camera system 50 can also include a speaker or any number of speakers. In a preferred embodiment the mobile camera system 50 can also simply be any camera and/or video recording device, which can be stationed at the respective vehicle or other moving or mobile object or entity and which can be utilized to obtain and record a respective picture, photograph, video, or video information, and to provide the respective picture, photograph, video, or video information, to the apparatus 100 and/or to the central processing computer 10 for use in connection with the apparatus 100 of the present invention.

With reference to FIG. 6, the mobile camera system 50 can include a central processing unit (CPU) 50A. The central processing unit (CPU) 50A may be a microprocessor, a microcomputer, a minicomputer, a macro-computer, or a mainframe computer, depending upon the application. The CPU 50A is specially programmed and/or specially configured to perform all of the functionality described herein as being performed by the mobile camera system 50.

The mobile camera system 50 can also include a random access memory (RAM) device(s) 50B and a read only memory (ROM) device(s) 50C which can be connected to the CPU 50A. The mobile camera system 50 can also include a user input device(s) 50D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the mobile camera system 50. The input device(s) 50D can be connected to the CPU 50A. In a preferred embodiment, data, information, instructions, or commands, can also be input by providing voice and/or audio instructions or commands via a microphone as an input device and by using voice recognition software.

The mobile camera system 50 can also include a display device 50E, such as a display monitor and/or a display screen, for providing the herein-described data and/or information to the user of the mobile camera system 50. The display device 50E can also include an external display device, an indicator light, an outdoor display screen, and/or a speaker or public address system, which can be located on the vehicle or moving or mobile object or entity and/or adjacent to the mobile camera system 50 so as to provide for the public display or dissemination of a signal, an indication, or a message, from the apparatus 100. For example, a color (for example, red) can be illuminated via the indicator light to signal that a person, of any age, is missing in the area, or a message can be provided via the outdoor display screen to broadcast a message, in any appropriate manner, to provide an alert that a person is missing in the area or in need of assistance, along with a description and/or a picture or photograph of the person, or a message can be played via or over the speaker or the public address system so as to provide a broadcast of information regarding the person and the situation to those persons present in the vicinity of the mobile camera system 50. The display device 50E can also be connected to the CPU 50A.

The mobile camera system 50 can also include an output device 50F, such as a printer, a display device, a speaker, and/or a modem, for outputting, in either or both of hard copy form or electronic form, any of the data and/or information which is described herein as being provided by, from, or at, the mobile camera system 50. The output device 50F can also include an external display device, an indicator light, an outdoor display screen, and/or a speaker or public address system, which can be located on the vehicle or moving or mobile object or entity and/or adjacent to the mobile camera system 50 so as to provide for the public display or dissemination of a signal, an indication, or a message, from the apparatus 100. As noted above, a color (for example, red) can be illuminated via the indicator light to signal that a person, of any age, is missing in the area, or a message can be provided via the outdoor display screen to broadcast a message, in any appropriate manner, to provide an alert that a person is missing in the area or in need of assistance, along with a description and/or a picture or photograph of the person, or a message can be played via or over the speaker or the public address system so as to provide a broadcast of information regarding the person and the situation to those persons present in the vicinity of the mobile camera system 50. The output device 50F can also be connected to the CPU 50A.

The mobile camera system 50 can also include a receiver 50G for receiving data and/or information, including any of the herein-described data and/or information, and/or any of the other data and/or information described herein as being provided to the mobile camera system 50 from any of the central processing computers 10, from any of the user communication devices 20, from any of the monitoring computers 30, from any of the camera systems 40, from any of the law enforcement computers 60, from any of the emergency services provider computers 70, or from any other mobile camera systems 50.

The mobile camera system 50 can also include a database(s) 50H, which can contain any data and/or information, and/or any software programs or software applications, which may be required, and/or which may be desired, for performing any of the functionality and/or processing routines described herein as being performed by the mobile camera system 50 and/or the apparatus 100.

In a preferred embodiment, the database 50H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the mobile camera system 50 to perform any and/or all of the various functions and functionalities described herein as being performed by the mobile camera system 50. The database 50H can also contain and/or can include any of the data and/or information regarding the mobile camera system 50, as well as regarding the owner(s) or operator(s) of the mobile camera system 40 and/or the vehicle or other moving or mobile object or entity associated with the mobile camera system 50, which are described herein as being stored in the database 10H of the central processing computer 10 or otherwise.

The database 50H can also contain and/or can include any data, information, reports, messages, activity reports, or any other data and/or information described herein as be used by, processed by, transmitted from, and/or received by, the mobile camera system 50 in performing any and/or of the functions or functionalities described herein as being performed by the mobile camera system 50. The database 50H can also contain and/or can include any data and/or information, as well as any and/or all software programs, software algorithms, and/or software applications or “apps”, needed, required, or desired, for enabling and allowing the mobile camera system 50 to perform any and/or all of the functions or functionalities described herein as being performed by the mobile camera system 50.

The mobile camera system 50 can also include a transmitter 501 for transmitting data and/or information, including any of the herein-described data and/or information, and/or any other data and/or information described herein as being provided by, from, or to, the mobile camera system 50, to any of the central processing computers, any of the user communication devices 20, any of the monitoring computers 30, any of the camera systems 40, any of the law enforcement computers 60, any of the emergency services provider computers 70, or any other mobile camera systems 50. The transmitter 501 can also be connected to the CPU 50A.

With reference once again to FIG. 6, the mobile camera system 50 can also include a video and/or audio recording device(s) 50J which can include one or more cameras and/or one or more video recording devices for recording pictures, photographs, videos, video information, and/or video clips, and/or one or more microphones or one or more audio recording devices for recording audio or audio clips, which can be recorded by, and/or transmitted live, by or from the mobile camera system 50, or which can be recorded by, and stored at or in, the mobile camera system 50 for transmission by or from the mobile camera system 50 at a later time. In a preferred embodiment, a microphone or an audio recording device can be associated with each camera or video recoding device of the mobile camera system 50. In another preferred embodiment, a single microphone or audio recording device can be associated with the mobile camera system 50. In a preferred embodiment, a separate and additional video and/or audio recording device(s) 50J can also be utilized to facilitate one-way broadcasts from the mobile camera system 50 by a user or operator of same, and/or can be utilized to facilitate video conferencing, video chatting, and/or audio conferencing, and/or video and audio conferencing, between any of the herein-described users, individuals, parties, or entities, who or which utilize the apparatus 100 and method of the present invention, and a user or operator of the mobile camera system 50. In this regard, the user or operator of the mobile camera system 50 can engage in telephone calls, video conference calls, and/or video conferencing calls, via the same. The user or operator of the mobile camera system 50 can also use the video and/or audio recording device(s) 50J to record and broadcast or transmit content via the transmitter 501.

With reference once again to FIG. 6, the mobile camera system 50 can also include a global positioning device 50K for determining the position or location of the mobile camera system 50. In a preferred embodiment, the global positioning device 50K can be utilized in order to determine or ascertain the position or location of the mobile camera system 50 at any time and/or for any reason or purpose.

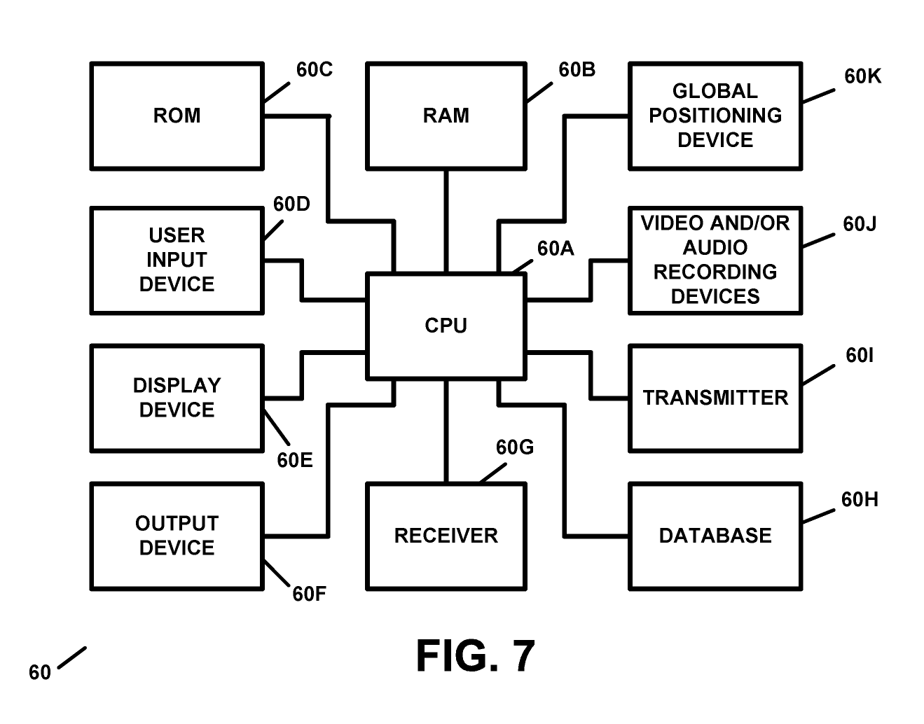

FIG. 7 illustrates the law enforcement computer 60 of FIG. 1, in block diagram form. In a preferred embodiment, the law enforcement computer 60 can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same.

With reference to FIG. 7, the law enforcement computer 60 includes a central processing unit (CPU) 60A. The central processing unit (CPU) 60A may be a microprocessor, a microcomputer, a minicomputer, a macro-computer, or a mainframe computer, depending upon the application. The CPU 60A is specially programmed and/or specially configured to perform all of the functionality described herein as being performed by the law enforcement computer 60.

The law enforcement computer 60 also includes a random access memory (RAM) device(s) 60B and a read only memory (ROM) device(s) 60C which are connected to the CPU 60A. The law enforcement computer 60 also includes a user input device(s) 60D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the law enforcement computer 60. The input device(s) 60D is also connected to the CPU 60A. In a preferred embodiment, data, information, instructions, or commands, can also be input by providing voice and/or audio instructions or commands via a microphone as an input device and by using voice recognition software.

The law enforcement computer 60 also includes a display device 60E, such as a display monitor and/or a display screen, for providing the herein-described data and/or information to the user of the law enforcement computer 60. The display device 60E is also connected to the CPU 60A.

The law enforcement computer 60 can also include an output device 60F, such as a printer, a display device, a speaker, and/or a modem, for outputting, in either or both of hard copy form or electronic form, any of the data and/or information which is described herein as being provided by, from, or at, the law enforcement computer 60. The output device 60F can also be connected to the CPU 60A.

The law enforcement computer 60 can also include a receiver 60G for receiving data and/or information, including any of the herein-described data and/or information, and/or any of the other data and/or information described herein as being provided to the law enforcement computer 60 from any of the central processing computers 10, from any of the user communication devices 20, from any of the monitoring computers 30, from any of the camera systems 40, from any of the mobile camera systems 50, from any emergency services provider computers 70, and/or from any other law enforcement computers 60.

The law enforcement computer 60 can also include a database(s) 60H, which can contain any data and/or information, and/or any software programs or software applications, which may be required, and/or which may be desired, for performing any of the functionality and/or processing routines described herein as being performed by the law enforcement computer 60 and/or the apparatus 100.

In a preferred embodiment, the database 60H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the law enforcement computer 60 to perform any and/or all of the various functions and functionalities described herein as being performed by the law enforcement computer 60. The database 60H can also contain and/or can include any of the data and/or information regarding the law enforcement computer 60, as well as regarding the law enforcement agency, police department, owner, or operator, of or associated with the law enforcement computer 60, which are described herein as being stored in the database 10H of the central processing computer 10 or otherwise.

The database 60H can also contain and/or can include any data, information, reports, messages, activity reports, or any other data and/or information described herein as be used by, processed by, transmitted from, and/or received by, the law enforcement computer 60 in performing any and/or of the functions or functionalities described herein as being performed by the law enforcement computer 60. The database 60H can also contain and/or can include any data and/or information, as well as any and/or all software programs, software algorithms, and/or software applications or “apps”, needed, required, or desired, for enabling and allowing the law enforcement computer 60 to perform any and/or all of the functions or functionalities described herein as being performed by the law enforcement computer 60.

The law enforcement computer 60 can also include a transmitter 601 for transmitting data and/or information, including any of the herein-described data and/or information, and/or any other data and/or information described herein as being provided by, from, or to, the law enforcement computer 60, to any of the central processing computers, any of the user communication devices 20, any of the monitoring computers 30, any of the camera systems 40, any of the mobile camera systems 50, any of the emergency services provider computers, or any other law enforcement computers 60. The transmitter 601 can also be connected to the CPU 60A.

With reference once again to FIG. 7, the law enforcement computer 60 can also include a video and/or audio recording device(s) 60J which can include one or more cameras and/or video recording devices for recording pictures or video and/or video clips and/or a microphone or an audio recording device for recording audio or audio clips which can be recorded by, and/or transmitted live, by or from the law enforcement computer 60, or which can be recorded by, and stored at or in, the law enforcement computer 60 for transmission by or from the law enforcement computer 60 at a later time. The video and/or audio recording device(s) 60J can also be utilized to facilitate one-way broadcasts from the law enforcement computer 60, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the law enforcement computer 60 can engage in telephone calls, video telephone calls, and/or video conferencing calls, via the same. The user or operator of the law enforcement computer 60 can also use the video and/or audio recording device(s) 60J to record and broadcast or transmit content via the transmitter 601.

With reference once again to FIG. 7, the law enforcement computer 60 can also include a global positioning device 60K for determining the position or location of the law enforcement computer 60. In a preferred embodiment, the global positioning device 60K can be utilized in order to determine or ascertain the position or location of law enforcement computer 60 at any time and/or for any reason or purpose.

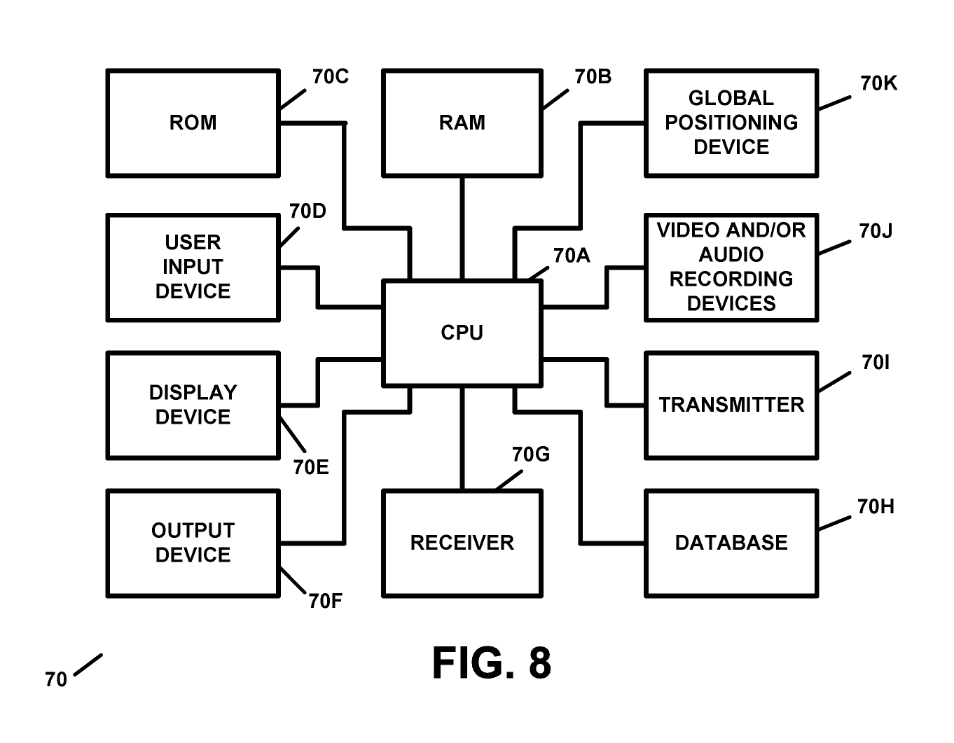

FIG. 8 illustrates the emergency services provider computer 70 of FIG. 1, in block diagram form. In a preferred embodiment, the emergency services provider computer 70 can be, or can include, any communication device, a computer, server computer, a computer terminal, a terminal device, a kiosk, a personal computer, a home computer, a laptop computer, a notebook computer, a tablet, a tablet computer, a personal communication device, a telephone, an interactive television, a smart phone or Smartphone, a cellular telephone, a wireless telephone, a videophone, a video telephone, a personal digital assistant, a beeper or a pager, a watch, an article or item of jewelry, a smart watch, a 360 degree video headset or interface, a VR (virtual reality) headset or interface, an AR (augmented reality) headset or interface, a wearable device or computer, eyeglasses, or any accessory, equipped with communications equipment, an implantable device or computer, or any combination of same.

With reference to FIG. 8, the emergency services provider computer 70 includes a central processing unit (CPU) 70A. The central processing unit (CPU) 70A may be a microprocessor, a microcomputer, a minicomputer, a macro-computer, or a mainframe computer, depending upon the application. The CPU 70A is specially programmed and/or specially configured to perform all of the functionality described herein as being performed by the emergency services provider computer 70.

The emergency services provider computer 70 also includes a random access memory (RAM) device(s) 70B and a read only memory (ROM) device(s) 70C which are connected to the CPU 70A. The emergency services provider computer 70 also includes a user input device(s) 70D which can be or can include any one or more of a keyboard, a touch screen keyboard, a scanner, a user pointing device, such as, for example, a mouse, an audio input device, a microphone, a camera, a video recording device, a touch pad, or a touch screen, or any other device or component for allowing data, information, instructions, or commands, to be entered into the emergency services provider computer 70. The input device(s) 70D is also connected to the CPU 70A. In a preferred embodiment, data, information, instructions, or commands, can also be input by providing voice and/or audio instructions or commands via a microphone as an input device and by using voice recognition software.

The emergency services provider computer 70 also includes a display device 70E, such as a display monitor and/or a display screen, for providing the herein-described data and/or information to the user of the emergency services provider computer 70. The display device 70E is also connected to the CPU 70A.

The emergency services provider computer 70 can also include an output device 70F, such as a printer, a display device, a speaker, and/or a modem, for outputting, in either or both of hard copy form or electronic form, any of the data and/or information which is described herein as being provided by, from, or at, the emergency services provider computer 70. The output device 70F can also be connected to the CPU 70A.

The emergency services provider computer 70 can also include a receiver 70G for receiving data and/or information, including any of the herein-described data and/or information, and/or any of the other data and/or information described herein as being provided to emergency services provider computer 70 from any of the central processing computers 10, from any of the user communication devices 20, from any of the monitoring computers 30, from any of the camera systems 40, from any of the mobile camera systems 50, from any of the law enforcement computers 60, or from any other emergency services provider computers 70.

The emergency services provider computer 70 can also include a database(s) 70H, which can contain any data and/or information, and/or any software programs or software applications, which may be required, and/or which may be desired, for performing any of the functionality and/or processing routines described herein as being performed by the emergency services provider computer 70 and/or the apparatus 100.

In a preferred embodiment, the database 70H can contain and/or can include any and/or all data and/or information, as well as any and/or all software programs, software algorithms, and/or software applications or “apps”, needed, required, or desired, described herein as being stored in the database 10H of the central processing computer 10 or otherwise, so as to enable the emergency services provider computer 70 to perform any and/or all of the various functions and functionalities described herein as being performed by the emergency services provider computer 70. The database 70H can also contain and/or can include any of the data and/or information regarding the emergency services provider computer 70, as well as regarding the law enforcement agency, police department, owner, or operator, of or associated with the emergency services provider computer 70, which are described herein as being stored in the database 10H of the central processing computer 10 or otherwise.

The database 70H can also contain and/or can include any data, information, reports, messages, activity reports, or any other data and/or information described herein as be used by, processed by, transmitted from, and/or received by, the emergency services provider computer 70 in performing any and/or of the functions or functionalities described herein as being performed by the emergency services provider computer 70. The database 70H can also contain and/or can include any data and/or information, as well as any and/or all software programs, software algorithms, and/or software applications or “apps”, needed, required, or desired, for enabling and allowing the emergency services provider computer 70 to perform any and/or all of the functions or functionalities described herein as being performed by the emergency services provider computer 70.

The emergency services provider computer 70 can also include a transmitter 701 for transmitting data and/or information, including any of the herein-described data and/or information, and/or any other data and/or information described herein as being provided by, from, or to, the emergency services provider computer 70, to any of the central processing computers, any of the user communication devices 20, any of the monitoring computers 30, any of the camera systems 40, any of the mobile camera systems 50, any of the law enforcement computers 60, or any other emergency services provider computers 70. The transmitter 701 can also be connected to the CPU 70A.

With reference once again to FIG. 8, the emergency services provider computer 70 can also include a video and/or audio recording device(s) 70J which can include one or more cameras and/or video recording devices for recording pictures or video and/or video clips and/or a microphone or an audio recording device for recording audio or audio clips which can be recorded by, and/or transmitted live, by or from the emergency services provider computer 70, or which can be recorded by, and stored at or in, the emergency services provider computer 70 for transmission by or from the emergency services provider computer 70 at a later time. The video and/or audio recording device(s) 70J can also be utilized to facilitate one-way broadcasts from the emergency services provider computer 70, and/or can be utilized to facilitate video conferencing, video chatting, and/or audio conferencing, and/or video and audio conferencing, between any of the herein-described users, individuals, parties, or entities, who or which utilize the apparatus 100 and method of the present invention. In this regard, the user or operator of the emergency services provider computer 70 can engage in telephone calls, video telephone calls, and/or video conferencing calls, via the same. The user or operator of the emergency services provider computer 70 can also use the video and/or audio recording device(s) 70J to record and broadcast or transmit content via the transmitter 701.

With reference once again to FIG. 8, the emergency services provider computer 70 can also include a global positioning device 70K for determining the position or location of the emergency services provider computer 70. In a preferred embodiment, the global positioning device 70K can be utilized in order to determine or ascertain the position or location of emergency services provider computer 70 at any time and/or for any reason or purpose.

The apparatus 100 and methods of the present invention can be utilized in numerous preferred embodiments in order to provide visual monitoring and/or video monitoring of individuals, vehicles, or articles or objects. It is envisioned that any individuals, vehicles, or articles or objects, who or which are to be monitored by the apparatus 100 can register or be registered with the apparatus 100 and/or the central processing computer 10. It is also envisioned that those users who are authorized, designated, or assigned, to monitor an individual, a vehicle, or an article or an object, can also register or be registered with the apparatus 100 and/or the central processing computer 10.

In a preferred embodiment, a user who is authorized to monitor an individual, a vehicle, or an article or object, can access the central processing computer 10 at any time and can request to obtain information for performing a visual monitoring and/or a video monitoring of or for the respective individual, vehicle, or article or object. In another preferred embodiment, any authorized employee or authorized personnel of any law enforcement agency or emergency services provider can also be deemed to be authorized to perform visual monitoring and/or video monitoring of or for the respective individual, vehicle, or article or object.

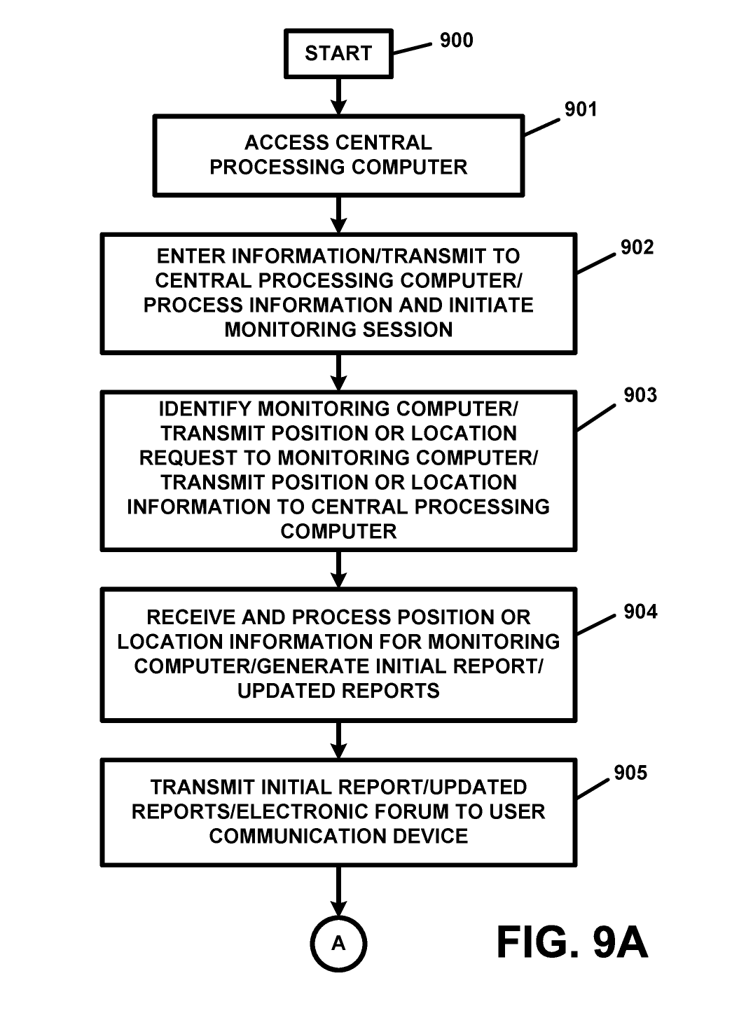

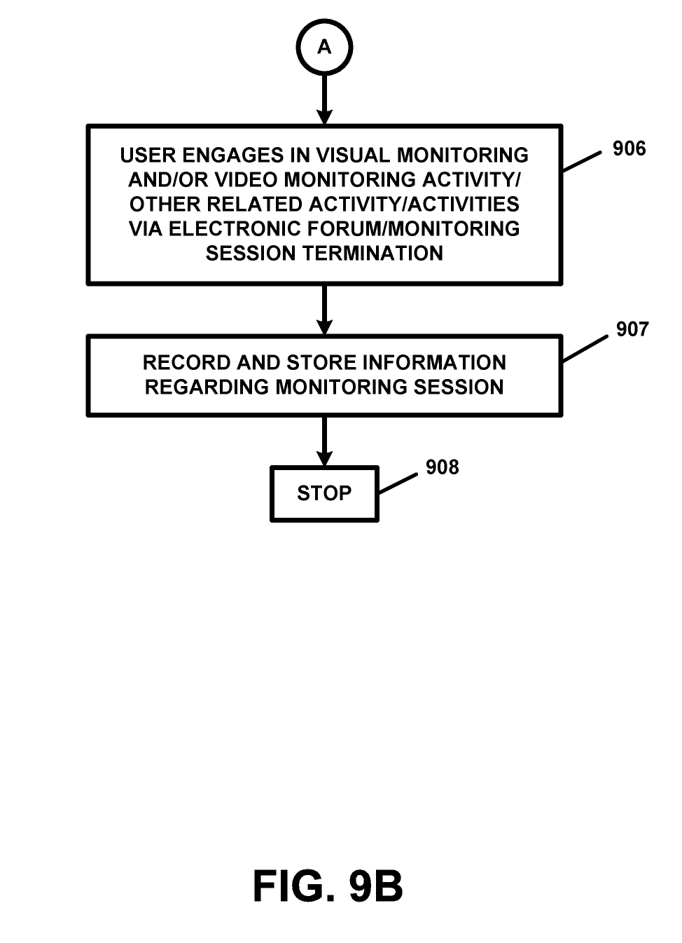

FIGS. 9A and 9B illustrate a preferred embodiment method for utilizing the apparatus 100 and methods of the present invention, in flow diagram form. Although the embodiment of FIGS. 9A and 9B is described in connection with monitoring an individual, it is important to note that the embodiment of FIGS. 9A and 9B, as described herein, can be utilized in a same, a similar, and/or an analogous, manner to monitor a vehicle or any article or object.

With reference to FIGS. 9A and 9B, the operation of the apparatus 100 commences at step 900. At step 901, a user, who is registered with the central processing computer 10 as being authorized to monitor an individual using the apparatus 100, can access the central processing computer 10 with or using his or her user communication device 20.

At step 902, the user can enter, into the user communication device 20, information regarding the identity of the individual whom the user is authorized to, and seeks to, monitor via the apparatus 100, along with information regarding the user's request to monitor the individual. At step 902, the information entered by the user at step 902 is transmitted to, and received by, the central processing computer 10. At step 902, the central processing computer 10 will process the information received, identify and authenticate the user and identify the individual to be monitored. At step 902, the central processing computer 10 will then initiate a monitoring session.

At step 903, the central processing computer 10 can identify the monitoring computer 30 used by the individual and can transmit, to the monitoring computer 30, a request to receive global positioning data or position or location data and/or information from the monitoring computer 30. At step 903, the monitoring computer 30 will receive and process the request to receive global positioning data or position or location data and/or information. At step 903, the global positioning device 30K can obtain the initial global positioning data or position or location data and/or information for the monitoring computer 30 and can transmit the same to the central processing computer 10. Thereafter, and for the duration of the monitoring session, the global positioning device 30K can obtain, and transmit to the central processing computer 10, any updated global positioning data or position or location data and/or information for the monitoring computer 30, at pre-determined time intervals which can be selected by the user at any time. For example, the user can select to have the global positioning data or position or location data and/or information updated every 15 or 20 seconds or any other selected or suitable time interval(s). In a preferred embodiment, the monitoring computer 30 will transmit, to the central processing computer 10, any and all updated global positioning data or position or location data and/or information for the duration of the monitoring session.

At step 904, the central processing computer 10 can receive and process the initial global positioning data or position or location data and/or information received from, and for, the monitoring computer 30 and identify all camera systems 40 and/or mobile camera systems 50 which are located or present within a pre-determined distance, or in the vicinity of, the monitoring computer 30. In a preferred embodiment, the location or position of the camera systems 40 would be previously stored for each camera system 40, and for each camera and/or video recording device of the camera system 40, in the database 10H. In a preferred embodiment, the mobile camera systems 50 can be programmed to automatically determine and transmit their global positioning data or position or location data and/or information to the central processing 10 computer in an on-going manner and at pre-determined time intervals which, in the preferred embodiment, are selected to provide the central processing computer 10 with the most accurate global positioning data or position or location information for the mobile camera systems 50 for use in monitoring the individual. In a preferred embodiment, the location or position of the mobile camera systems 50 are stored in the database 10H and updated in an on-going manner or on an on-going basis.

At step 904, the central processing computer 10 can generate an initial report containing information regarding the position or location of the monitoring computer 30 and any camera systems 40 and/or mobile camera systems 50 located or present within a pre-determined distance, or in the vicinity of, the monitoring computer 30. At step 904, the central processing computer 10 can generate an updated report each time it receives an update regarding the position or location of monitoring computer 30 and/or an update in the position or location information for any camera(s) 40 and/or an update in the global positioning data or position or location information for the mobile camera systems 50. In a preferred embodiment, the initial report as well all updated reports can contain information regarding the position or location of monitoring computer 30 as well as links or hyperlinks to all of the identified camera systems 40 and/or mobile camera systems 50 which are located or present within a pre-determined distance, or in the vicinity of, the monitoring computer 30. In a preferred embodiment, pictures, photographs, video information, or videos, can be obtained from each respective camera system 40, or any camera(s) or video recording device(s) of same, or the respective mobile camera system 50, or any camera(s) or video recording device(s) of same, via the associated link or hyperlink to same.

At step 905, the central processing computer 10 can transmit the initial report and any updates reports to the user communication device 20. In a preferred embodiment, the report can be viewed via an electronic forum which can be transmitted to the user communication device 20, and can be provided on, and viewable via, the display device 20E of the user communication device 20. The central processing computer 10 can generate, and transmit to the user communication device 20, updated reports throughout, and for the duration of, the monitoring session.

At step 906, the user can engage in visually monitoring and/or video monitoring the individual via the electronic forum provided to his or her user communication device. At step 906, in a preferred embodiment, the user can engage in a number of activities via the user communication device 20 in and/or while visually monitoring and/or in video monitoring the individual. In a preferred embodiment, the user can select to view pictures, photographs, video information, and/or videos, or live streaming videos, obtained with or from any camera system 40 or any mobile camera system 50, or from any individual camera or video recording device of same, which is included in the initial report or any updated reports. In a preferred embodiment the initial report and the updated reports, which can be time-stamped and date-stamped, can be provided to, listed in, and accessed via, the electronic forum. In this regard, historical information regarding the monitoring session and movement or activities of the individual can be recorded and stored in an archived and/or any other appropriate manner.

In a preferred embodiment, pictures, photographs, video information, and/or videos, or live streaming videos, obtained with or from any cameras or video recording devices or any camera system 40 or mobile camera system 50 can also be selected and viewed, by the user, via individual links or hyperlinks to same in the initial report and updated reports.

In a preferred embodiment, audio information recorded by any microphone(s) and/or audio recording device(s) of any camera system 40 or of any mobile camera system 50 can also be accessed, and listened to, by the user, such as via a link or hyperlink to the respective microphone and/or audio recording device included in the initial report or any updated reports, and via a speaker of the output device 20F of the user communication device 20.

In a preferred embodiment, the user can save any of the initial report, any updated reports, any pictures, photographs, video information, videos, or live streaming videos, viewed and/or any audio information listened to, in a file created for the monitoring session.

In this regard, the user can view and visually monitor and/or video monitor the individual during the monitoring session, as well as listen to any associated audio information obtained in the vicinity of the individual.

In a preferred embodiment, at step 906, the user can also make a report, via a suitable link in the initial report or updated report being viewed via the electronic forum, to a law enforcement agency or police department, in the geographical area or political subdivision in which the individual is located, so as to request assistance for the individual and/or to make a report regarding any circumstances related to, or resulting from what was viewed or listened to during, the monitoring session. Thereafter, the monitoring session, the initial report, any updated reports, and any pictures, photographs, video information, videos, or live streaming videos, viewed and/or any audio information, contained in or accessed via the initial report and any updated reports can be viewed by law enforcement personnel via a law enforcement computer 60 and/or a user communication device 20 used by law enforcement personnel. The electronic forum can also be provided to the respective law enforcement computer 60 and/or a user communication device 20 used by law enforcement personnel. Thereafter, the law enforcement personnel can take any needed or suitable action to assist the individual, if needed.

In a preferred embodiment, at step 906, the user can also make a report, via a suitable link in the initial report or updated report being viewed via the electronic forum, to an emergency services provider in the geographical area or political subdivision in which the individual is located, so as to request assistance for the individual and/or to make a report regarding any circumstances related to, or resulting from what was viewed or listened to during, the monitoring session. Thereafter, the monitoring session, the initial report, any updated reports, and any pictures, photographs, video information, videos, or live streaming videos, viewed and/or any audio information, contained in or accessed via the initial report and any updated reports can be viewed by emergency services personnel via an emergency services provider computer 70 and/or a user communication device 20 used by emergency services personnel. The electronic forum can also be provided to the respective emergency services provider computer 70 and/or a user communication device 20 used by emergency services personnel. Thereafter, the emergency services personnel can take any needed or suitable action to assist the individual, if needed. In a preferred embodiment, the user can also, at step 906, by transmitting a suitable control signal, from the user communication device 20, to the central processing computer 10, control and/or activate an operation of the monitoring computer 30, and/or control and/or activate an operation of any camera system 40, or any camera(s), video recording device(s), microphone(s), audio recording device(s), and/or speaker(s) of the camera system 40, and/or control and/or activate an operation of any mobile camera system 50, or any camera(s), video recording device(s), microphone(s), audio recording device(s), and/or speaker(s) of the mobile camera system 50. In a preferred embodiment, the user, at step 906, can also cause a pre-recorded visual message, or a live visual message recorded at the user communication device 20, to be displayed via a display screen of or associated with a camera system(s) 40 or a mobile camera system(s) 50, can also cause a pre-recorded audio message, or a live audio message recorded at the user communication device 20, to be broadcast via a speaker of or associated with a camera system(s) 40 or a mobile camera system(s) 50, and/or can cause a signal or indication to be provided via the camera system(s) 40 or mobile camera system(s) 50 such as by providing a red light or other indication signifying that the individual is in need of assistance.

In the above-described manner, the user can perform visual monitoring and/or video monitoring of and for the individual by viewing the individual in or along his or her travels and/or by engaging in any one or more, or any number, of the activities described herein which can be performed by the user at and/or during step 906.

In a preferred embodiment, the user can perform any number of the herein-described activities in the electronic forum and/or during the duration of the monitoring session until the monitoring session is terminated by the user or the central processing computer 20. In a preferred embodiment, any number of any pictures, photographs, videos, or live streaming videos, can be viewed by the user via the display device 20E in the electronic forum. Upon termination of the monitoring session, the central processing computer will cease providing the electronic forum to the user communication device 20 and the operation of the apparatus will proceed to step 907.

At step 907, the central processing computer 10 can record and store, in a monitoring session report which will be generated for the monitoring session, and stored in a monitoring session file, any and/or all data and/or information regarding the monitoring session, including, but not limited to, the initial report, any and/or all updated reports, any pictures, photographs, video information, videos, or live streaming videos, viewed, and/or any audio information listened to, by the user, and/or any data and/or information related thereto, the individual's movement and/or movements provided on a digitized map as provided in the electronic forum during the monitoring session, and/or any and/or all information regarding any actions taken by, and/or any activities performed by, the user during the monitoring session. At step 907, the monitoring session report can be stored in the database 10H and can be transmitted by the central processing computer 10 to, and received and stored at, the user's user communication device 20, the law enforcement computer 60, and/or the emergency services provider computer 70. Thereafter, the operation of the apparatus 100 will cease at step 908.

In another preferred embodiment, at any time during steps 901 through 907 of the operation of the apparatus 100, or at any time during the monitoring session, the user can initiate and/or engage in a telephone call, a video telephone call, or a video conference call, with the individual via his or her user communication device 20 and/or the electronic forum. In such an embodiment, the individual can establish a communication link between his or her user communication device 20 and the individual's monitoring computer 30 in order to conduct such a telephone call, a video telephone call, or video conference call. In a preferred embodiment, at any time during steps 901 through 906 of the operation of the apparatus 100, or at any time during the monitoring session, the individual can initiate and/or engage in a telephone call, a video telephone call, or a video conference call, with the user via the individual's monitoring computer 30. In such an embodiment, the individual can establish a communication link between his or her monitoring computer 30 and the individual's user communication device 20. Any telephone call, video telephone call, or video conference call, can be recorded, stored, and/or included, in the monitoring session report and/or in the monitoring session file.

As noted above, although described as being used to perform visual monitoring and/or video monitoring of and for an individual, the embodiment of FIGS. 9A and 9B can be utilized in a same, a similar, and/or an analogous, manner to allow any authorized user, owner, or operator, to perform visual monitoring and/or video monitoring of and for any vehicle or any article or object. In this regard, any and/or all the above-described steps, functions, and/or functionalities, described as being used in connection with performing visual monitoring and/or video monitoring of and for an individual can be utilized, as described herein, for performing visual monitoring and/or video monitoring of and for any vehicle or any article or object.

In another preferred embodiment, the apparatus 100 or the central processing computer 10 can be programmed to detect an occurrence of an event, which can result in a need or desire for the user to perform a visual monitoring and/or a video monitoring of or for a respective individual, vehicle, or article or object. Upon detecting the occurrence of the event, the central processing computer 20 can generate a notification message and can transmit the same to the user communication device 20 associated with, or used by, a user who is authorized to monitor the individual, the vehicle, or the article or object. Thereafter, the user can perform a visual monitoring and/or a video monitoring of the respective individual, vehicle, or article or object, via the apparatus 100.

In a preferred embodiment, the event, the occurrence of which can be detected, can be an occurrence of the individual requesting either assistance or requesting to be visually monitored and/or video monitored, with such request being made by the individual via the monitoring computer 30, an occurrence of an automatic request, transmitted from the monitoring computer 30, which can be programmed to automatically generate and transmit the request at a certain time or under certain pre-defined conditions, that the individual be visually monitored and/or video monitored, and/or the occurrence can be a request made by any other user, authorized to visually monitor and/or video monitor the individual, or made by any law enforcement agency or emergency services provider, or made by any other authorized third party, to visually monitor and/or video monitor the individual.

In the case of a vehicle or an article or object, the event, the occurrence of which can be detected, can be an occurrence of an owner or operator of the vehicle or the article or object requesting that the same be visually monitored and/or video monitored, an occurrence of the vehicle or the article or object, which can be programmed to automatically generate and transmit the request at a certain time or under certain pre-defined conditions, generate and transmit the request to be visually monitored and/or video monitored, and/or the occurrence can be a request made by any other user, authorized to visually monitor and/or video monitor the vehicle or article or object, or made by any law enforcement agency or emergency services provider, or made by any other authorized third party, to visually monitor and/or video monitor the vehicle or article or object.

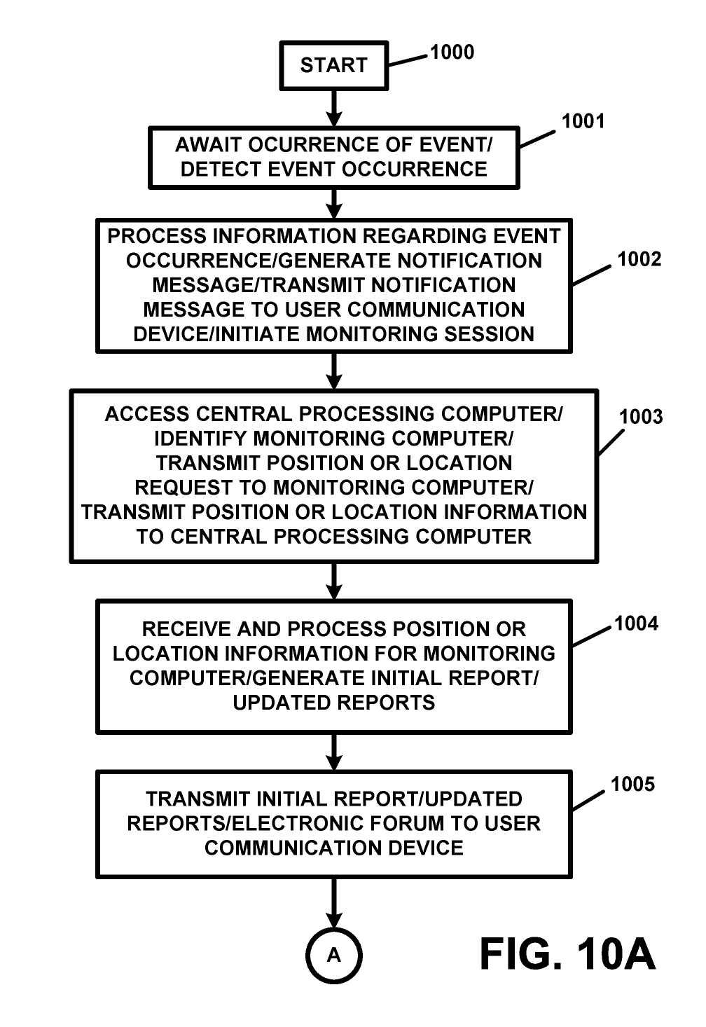

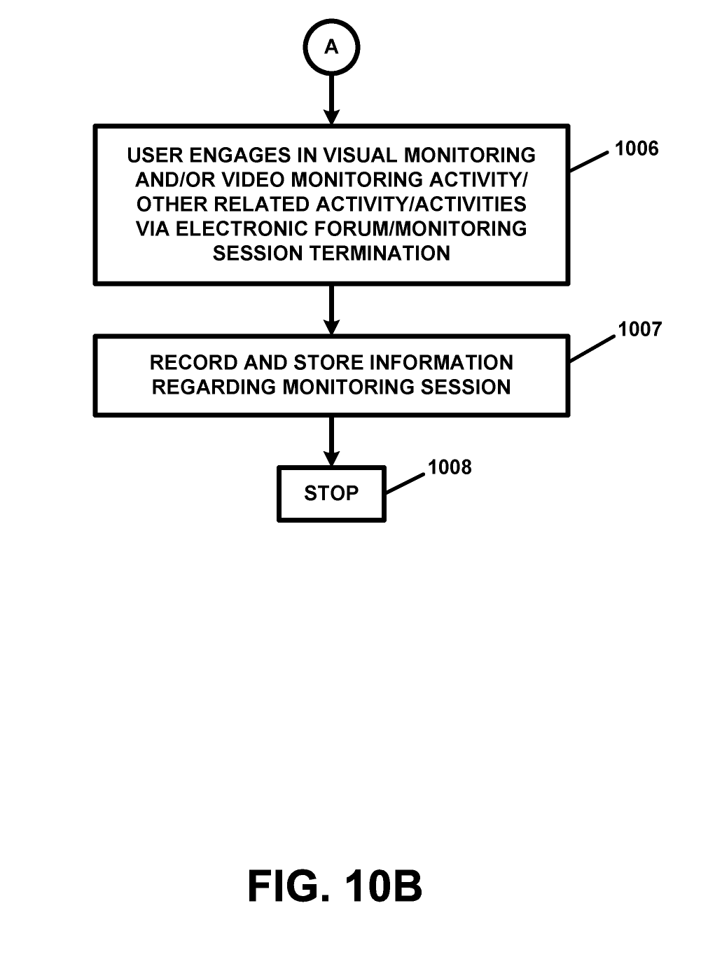

FIGS. 10A and 10B illustrate a preferred embodiment method for utilizing the apparatus 100 and methods of the present invention, in flow diagram form. Although the embodiment of FIGS. 10A and 10B is described in connection with monitoring an individual, it is important to note that the embodiment of FIGS. 10A and 10B, as described herein, can be utilized in a same, a similar, and/or an analogous, manner to monitor a vehicle or any article or object.

With reference to FIGS. 10A and 10B, the operation of the apparatus 100 commences at step 1000. At step 1001, the central processing computer 10 can await an occurrence of an event which can result in the user being notified. As noted herein, the event can be an occurrence of the individual requesting either assistance or requesting to be visually monitored and/or video monitored, with such request being made by the individual via the monitoring computer 30, an occurrence of an automatic request, transmitted from the monitoring computer 30, which can be programmed to automatically generate and transmit the request at a certain time or under certain other conditions, that the individual be visually monitored and/or video monitored, and/or a request made by any other user, authorized to visually monitor and/or video monitor the individual, or made by any law enforcement agency or emergency services provider, or made by any other authorized third party, to visually monitor and/or video monitor the individual. Upon detecting the occurrence of the event, the operation of the apparatus will proceed to step 1002.

At step 1002, the central processing computer 10 will process information regarding the occurrence of the event, the individual who is to be the subject of the visual monitoring and/or video monitoring activity, and the user who is to be notified. At step 1002, the central processing computer 10 will generate a notification message and transmit the notification message to the user communication device 20 of the user who is to be notified of the same. At step 1002, the central processing computer 10 can also initiate a monitoring session for the user. In a preferred embodiment, the notification message can contain or include a link or hyperlink to the central processing computer 10 and/or to the electronic forum in which the user can engage in the monitoring session.

At step 1003, the user can access the central processing computer 10 in order to engage in the visual monitoring and/or video monitoring of the individual and/or to engage in the monitoring session. In a preferred embodiment, the user can either access the central processing computer 10 via his or her user communication device 20 and then access the electronic forum, and/or the user can access the central processing computer 10 and the electronic forum directly, with his or her user communication device 20, via the link or hyperlink in the notification message.

At step 1003, the central processing computer 10 can perform any needed operations, actions, or functions, for identifying the monitoring computer 30 used by the individual and transmitting, to the monitoring computer 30, a request to receive global positioning data or position or location data and/or information from the monitoring computer 30. At step 1003, the monitoring computer 30 will receive and process the request to receive global positioning data or position or location data and/or information. At step 1003, the global positioning device 30K can obtain the initial global positioning data or position or location data and/or information for the monitoring computer 30 and can transmit same to the central processing computer 10. Thereafter, and for the duration of the monitoring session, the global positioning device 30K can obtain, and transmit to the central processing computer 10, any updated global positioning data or position or location data and/or information for the monitoring computer 30, at pre-determined time intervals which can be selected by the user at any time. For example, the user can select to have the global positioning data or position or location data and/or information updated every 15 or 20 seconds or at any other selected or suitable time interval(s). In a preferred embodiment, the monitoring computer 30 will transmit, to the central processing computer 10, any and all updated global positioning data or position or location data and/or information for the duration of the monitoring session.

At step 1004, the central processing computer 10 can receive and process the initial global positioning data or position or location data and/or information received from, and for, the monitoring computer 30 and identify all camera systems 40 and/or mobile camera systems 50 which are located or present within a pre-determined distance, or in the vicinity of, the monitoring computer 30. In a preferred embodiment, the location or position of the camera systems 40 would be previously stored for each camera system 40, and for each camera and/or video recording device of the camera system 40, in the database 10H. In a preferred embodiment, the mobile camera systems 50 can be programmed to automatically determine and transmit their global positioning data or position or location data and/or information to the central processing 10 computer in an on-going manner and at pre-determined time intervals which, in the preferred embodiment, are selected to provide the central processing computer 10 with the most accurate global positioning data or position or location information for the mobile camera systems 50 for use in monitoring the individual. In a preferred embodiment, the location or position of the mobile camera systems 50 are stored in the database 10H and updated in an on-going manner or on an on-going basis.

At step 1004, the central processing computer 10 can generate an initial report containing information regarding the position or location of the monitoring computer 30 and any camera systems 40 and/or mobile camera systems 50 located or present within a pre-determined distance, or in the vicinity of, the monitoring computer 30. At step 1004, the central processing computer 10 can generate an updated report each time it receives an update regarding the position or location of monitoring computer 30 and/or an update in the position or location information for any camera(s) 40 and/or an update in the global positioning data or position or location information for the mobile camera systems 50. In a preferred embodiment, the initial report as well all updated reports can contain information regarding the position or location of monitoring computer 30 as well as links or hyperlinks to all of the identified camera systems 40 and/or mobile camera systems 50 which are located or present within a pre-determined distance, or in the vicinity of, the monitoring computer 30. In a preferred embodiment, pictures, photographs, video information, or videos, can be obtained from each respective camera system 40, or any camera(s) or video recording device(s) of same, or the respective mobile camera system 50, or any camera(s) or video recording device(s) of same, via the associated link or hyperlink to same.

At step 1005, the central processing computer 10 can transmit the initial report and any updates reports to the user communication device 20. In a preferred embodiment, the report can be viewed via an electronic forum which can be transmitted to the user communication device 20, and can be provided on, and viewable via, the display device 20E of the user communication device 20. The central processing computer 10 can generate, and transmit to the user communication device 20, updated reports throughout, and for the duration of, the monitoring session.

At step 1006, the user can engage in visually monitoring and/or video monitoring the individual via the electronic forum provided to his or her user communication device. At step 1006, in a preferred embodiment, the user can engage in a number of activities via the user communication device 20 in and/or while visually monitoring and/or in video monitoring the individual. In a preferred embodiment, the user can select to view pictures, photographs, video information, and/or videos, or live streaming videos, obtained with or from any camera system 40 or any mobile camera system 50, or from any individual camera or video recording device of same, which is included in the initial report or any updated reports. In a preferred embodiment the initial report and the updated reports, which can be time-stamped and date-stamped, can be provided to, listed in, and accessed via, the electronic forum. In this regard, historical information regarding the monitoring session and movement or activities of the individual can be recorded and stored in an archived and/or any other appropriate manner.

In a preferred embodiment, pictures, photographs, video information, and/or videos, or live streaming videos, obtained with or from any cameras or video recording devices or any camera system 40 or mobile camera system 50 can also be selected and viewed, by the user, via individual links or hyperlinks to same in the initial report and updated reports.

In a preferred embodiment, audio information recorded by any microphone(s) and/or audio recording device(s) of any camera system 40 or of any mobile camera system 50 can also be accessed, and listened to, by the user, such as via a link or hyperlink to the respective microphone and/or audio recording device included in the initial report or any updated reports, and via a speaker of the output device 20F of the user communication device 20.

In a preferred embodiment, the user can save any of the initial report, any updated reports, any pictures, photographs, video information, videos, or live streaming videos, viewed and/or any audio information listened to, in a file created for the monitoring session.

In this regard, the user can view and visually monitor and/or video monitor the individual during the monitoring session, as well as listen to any associated audio information obtained in the vicinity of the individual.

In a preferred embodiment, at step 1006, the user can also make a report, via a suitable link in the initial report or updated report being viewed via the electronic forum, to a law enforcement agency or police department, in the geographical area or political subdivision in which the individual is located, so as to request assistance for the individual and/or to make a report regarding any circumstances related to, or resulting from what was viewed or listened to during, the monitoring session. Thereafter, the monitoring session, the initial report, any updated reports, and any pictures, photographs, video information, videos, or live streaming videos, viewed and/or any audio information, contained in or accessed via the initial report and any updated reports can be viewed by law enforcement personnel via a law enforcement computer 60 and/or a user communication device 20 used by law enforcement personnel. The electronic forum can also be provided to the respective law enforcement computer 60 and/or a user communication device 20 used by law enforcement personnel. Thereafter, the law enforcement personnel can take any needed or suitable action to assist the individual, if needed.

In a preferred embodiment, at step 1006, the user can also make a report, via a suitable link in the initial report or updated report being viewed via the electronic forum, to an emergency services provider in the geographical area or political subdivision in which the individual is located, so as to request assistance for the individual and/or to make a report regarding any circumstances related to, or resulting from what was viewed or listened to during, the monitoring session. Thereafter, the monitoring session, the initial report, any updated reports, and any pictures, photographs, video information, videos, or live streaming videos, viewed and/or any audio information, contained in or accessed via the initial report and any updated reports can be viewed by emergency services personnel via an emergency services provider computer 70 and/or a user communication device 20 used by emergency services personnel. The electronic forum can also be provided to the respective emergency services provider computer 70 and/or a user communication device 20 used by emergency services personnel. Thereafter, the emergency services personnel can take any needed or suitable action to assist the individual, if needed.

In a preferred embodiment, the user can also, at step 1006, by transmitting a suitable control signal, from the user communication device 20, to the central processing computer 10, control and/or activate an operation of the monitoring computer 30, and/or control and/or activate an operation of any camera system 40, or any camera(s), video recording device(s), microphone(s), audio recording device(s), and/or speaker(s) of the camera system 40, and/or control and/or activate an operation of any mobile camera system 50, or any camera(s), video recording device(s), microphone(s), audio recording device(s), and/or speaker(s) of the mobile camera system 50. In a preferred embodiment, the user, at step 1006, can also cause a pre-recorded visual message, or a live visual message recorded at the user communication device 20, to be displayed via a display screen of or associated with a camera system(s) 40 or a mobile camera system(s) 50, can also cause a pre-recorded audio message, or a live audio message recorded at the user communication device 20, to be broadcast via a speaker of or associated with a camera system(s) 40 or a mobile camera system(s) 50, and/or can cause a signal or indication to be provided via the camera system(s) 40 or mobile camera system(s) 50 such as by providing a red light or other indication signifying that the individual is in need of assistance.

In the above-described manner, the user can perform visual monitoring and/or video monitoring of and for the individual by viewing the individual in or along his or her travels and/or by engaging in any one or more, or any number, of the activities described herein which can be performed by the user at and/or during step 1006.

In a preferred embodiment, the user can perform any number of the herein-described activities in the electronic forum and/or during the duration of the monitoring session until the monitoring session is terminated by the user or the central processing computer 20. In a preferred embodiment, any number of any pictures, photographs, videos, or live streaming videos, can be viewed by the user via the display device 20E in the electronic forum. Upon termination of the monitoring session, the central processing computer will cease providing the electronic forum to the user communication device 20 and the operation of the apparatus will proceed to step 1007.

At step 1007, the central processing computer 10 can record and store, in a monitoring session report which will be generated for the monitoring session, and stored in a monitoring session file, any and/or all data and/or information regarding the monitoring session, including, but not limited to, the initial report, any and/or all updated reports, any pictures, photographs, video information, videos, or live streaming videos, viewed, and/or any audio information listened to, by the user, and/or any data and/or information related thereto, the individual's movement and/or movements provided on a digitized map as provided in the electronic forum during the monitoring session, and/or any and/or all information regarding any actions taken by, and/or any activities performed by, the user during the monitoring session. At step 1007, the monitoring session report can be stored in the database 10H and can be transmitted by the central processing computer 10 to, and received and stored at, the user's user communication device 20, the law enforcement computer 60, and/or the emergency services provider computer 70. Thereafter, the operation of the apparatus 100 will cease at step 1008.

In another preferred embodiment, at any time during steps 1001 through 1007 of the operation of the apparatus 100, or at any time during the monitoring session, the user can initiate and/or engage in a telephone call, a video telephone call, or a video conference call, with the individual via his or her user communication device 20 and/or the electronic forum. In such an embodiment, the individual can establish a communication link between his or her user communication device 20 and the individual's monitoring computer 30 in order to conduct such a telephone call, a video telephone call, or a video conference call. In a preferred embodiment, at any time during steps 1001 through 1007 of the operation of the apparatus 100, or at any time during the monitoring session, the individual can initiate and/or engage in a telephone call, a video telephone call, or a video conference call, with the user via the individual's monitoring computer 30. In such an embodiment, the individual can establish a communication link between his or her monitoring computer 30 and the individual's user communication device 20. Any telephone call, video telephone call, or video conference call, can be recorded, stored, and/or included, in the monitoring session report and/or in the monitoring session file.

As noted above, although described as being used to perform visual monitoring and/or video monitoring of and for an individual, the embodiment of FIGS. 10A and 10B can be utilized in a same, a similar, and/or an analogous, manner to allow any authorized user, owner, or operator, to perform visual monitoring and/or video monitoring of and for any vehicle or any article or object. In this regard, any and/or all the above-described steps, functions, and/or functionalities, described as being used in connection with performing visual monitoring and/or video monitoring of and for an individual can be utilized, as described herein, for performing visual monitoring and/or video monitoring of and for any vehicle or any article or object.

The apparatus 100 and methods of the present invention can be utilized to allow an authorized user to perform visual monitoring and/or video monitoring of any individual, vehicle, or article or object, by viewing pictures, photographs, video information, videos, and/or live streaming videos, obtained by camera systems and/or mobile camera systems which are determined to be within a predetermined distance of, or within the vicinity, of the respective individual, vehicle, or article or object, which is the subject of the visual monitoring and/or video monitoring activity. The apparatus 100 of the present invention can also allow an authorized user to perform any number of activities, operations, or function, while performing a visual monitoring and/or video monitoring of any individual, vehicle, or article or object.

In any and/or all of the embodiments described herein, the central processing computer 10 can be programmed to detect a request made by any authorized user to visually monitor and/or video monitor an individual, a vehicle, or an article or object, and to generate a request notification report, containing information regarding the request, information regarding the requesting user, and a link or hyperlink to an electronic forum for the visual monitoring and/or video monitoring activity. Thereafter, the central processing computer 10 can transmit the request notification report to the user communication device 20 of or associated with each user authorized to visually monitor and/or video monitor the respective individual, vehicle, or article or object. A user receiving the request notification report can view same via his or her user communication device 20 and/or link to the electronic forum so as to engage in, or so as to monitor or observe, the visual monitoring and/or video monitoring activity.

In any and/or all of the embodiments described herein, any and/or all of the messages and/or reports described herein can be transmitted is, as, or as an attachment to, an e-mail message, a text message, and instant message, an SMS message, a telephone call, a pre-recorded telephone call, a facsimile (fax) transmission, or an electronic transmission of any kind or type.

In any and/or all of the embodiments described herein, the apparatus 100 and/or the central processing computer 10, the user communication devices 20, the monitoring computers 30, the camera systems 40, the mobile camera systems 50, the law enforcement computers 60, and/or the emergency services provider computers 70, can be programmed for automatic activation and/or operation and/or programmed activation and/or operation.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus, comprising:
a database, wherein the database stores information regarding an individual or an entity, information regarding a monitoring computer associated with the individual or the entity and located with, at, or on, the individual or the entity, information regarding a user authorized to visually monitor or video monitor the individual or the entity, information regarding a plurality of camera systems, wherein each of the camera systems includes a camera or a video recording device or a plurality of cameras or video recording devices, and information for facilitating a visual monitoring or a video monitoring of the individual or the entity;
a processor, wherein the processor is specially programmed to process a request by the user to perform a visual monitoring or a video monitoring of the individual or the entity, to determine or to ascertain a position or location of the monitoring computer with, at, or on, the individual or the entity, to identify a camera or a video recording device or a plurality of cameras or video recording devices in a vicinity of the monitoring computer or the individual or the entity, and to provide an electronic forum to a communication device associated with the user;
a receiver, wherein the receiver receives position or location information transmitted from the monitoring computer; and
a transmitter, wherein the transmitter transmits the electronic forum to the communication device associated with the user,
wherein the apparatus receives a request from the user communication device to visually monitor or video monitor the individual or the entity, wherein the apparatus transmits a position or location request message to the monitoring device, wherein the apparatus receives information regarding the position or location of the monitoring computer, wherein the apparatus processes the information regarding the position or location of the monitoring computer with information stored in the database to identify a camera or a video recording device or a plurality of cameras or video recording devices in a vicinity of the monitoring computer or the individual or the entity, and further wherein the apparatus generates a report containing information regarding the position or location of the monitoring computer, information regarding the camera or the video recording device or the plurality of cameras or video recording devices in a vicinity of the monitoring computer or the individual or the entity, and a link or a hyperlink to a picture, a photograph, video information, or live streaming video, obtained by the camera or the video recording device, or obtained by each of the plurality of cameras or video recording devices, wherein the apparatus transmits the report to the user communication device, and further wherein the report is viewable via a display device of the user communication device, wherein the picture, the photograph, the video information, or the live streaming video, obtained by the camera or the video recording device, or obtained by each of the plurality of cameras or video recording devices, is viewable via the electronic forum on the display device.

2. The apparatus of claim 1, wherein the individual or the entity is an individual.

3. The apparatus of claim 1, wherein the individual or the entity is a vehicle.

4. The apparatus of claim 1, wherein the individual or the entity is an article or an object.

5. The apparatus of claim 1, wherein the apparatus transmits the electronic forum and the report to a law enforcement computer.

6. The apparatus of claim 1, wherein the apparatus transmits the electronic forum and the report to an emergency services provider computer.

7. The apparatus of claim 1, wherein at least one camera system of the plurality of camera systems is located at a fixed location.

8. The apparatus of claim 1, wherein at least one camera system of the plurality of camera systems is a mobile camera system.

9. The apparatus of claim 8, wherein the mobile camera system is located at or on a vehicle.

10. The apparatus of claim 9, wherein the vehicle is motor vehicle, an automobile, a bus, or a mass transportation vehicle.

11. The apparatus of claim 9, wherein the vehicle is a drone.

12. The apparatus of claim 1, wherein the camera system further comprises an output device, wherein the output device is a display screen, and further wherein the display screen displays a message selected or provided by the user.

13. The apparatus of claim 1, wherein the camera system further comprises an output device, wherein the output device is a speaker, and further wherein the speaker broadcasts a message selected or provided by the user.

14. The apparatus of claim 1, wherein the apparatus controls or activates an operation of the monitoring computer or at least one camera system of the plurality of camera systems.

15. The apparatus of claim 1, wherein the apparatus facilitates a telephone call, a video telephone call, or a video conference call, between the user and the individual via the electronic forum and the display device.

16. The apparatus of claim 1, wherein the apparatus detects an end of a monitoring session, and stores and record information regarding an activity of the user in the electronic forum or stores and records the picture, the photograph, the video information, or the live streaming video, viewed by the user.

17. The apparatus of claim 1, wherein the apparatus transmits updated reports to the user communication device, wherein each updated report of the updated reports contains updated information regarding the position or location of the monitoring computer, updated information regarding the camera or the video recording device or the plurality of cameras or video recording devices in a vicinity of the monitoring computer or the individual or the entity, and a link or a hyperlink to a picture, a photograph, video information, or live streaming video, obtained by the camera or the video recording device, or obtained by each of the plurality of cameras or video recording devices.

18. The apparatus of claim 1, wherein the apparatus is programmed to detect a request by the individual to visually monitor or video monitor the individual.

19. The apparatus of claim 1, the apparatus is programmed to detect a second request by a second user to monitor the individual, and further wherein the processor generates a second report containing information regarding the second request and information regarding the second user, and further wherein the apparatus transmits the second report to the user communication device.

20. An apparatus, comprising:
a database, wherein the database stores information regarding an individual or an entity, information regarding a monitoring computer associated with the individual or the entity and located with, at, or on, the individual or the entity, information regarding a user authorized to visually monitor or video monitor the individual or the entity, information regarding a plurality of camera systems, wherein each of the camera systems includes a camera or a video recording device or a plurality of cameras or video recording devices, and information for facilitating a visual monitoring or a video monitoring of the individual or the entity;
a processor, wherein the processor is specially programmed to detect an occurrence of an event giving rise to a need to perform a visual monitoring or a video monitoring of the individual or the entity, to determine or to ascertain a position or location of the monitoring computer with, at, or on, the individual or the entity, to identify a camera or a video recording device or a plurality of cameras or video recording devices in a vicinity of the monitoring computer or the individual or the entity, and to provide an electronic forum to a communication device associated with the user;
a receiver, wherein the receiver receives position or location information transmitted from the monitoring computer; and
a transmitter, wherein the transmitter transmits the electronic forum to the communication device associated with the user,
wherein the apparatus detects the occurrence of the event giving rise to a need to perform a visual monitoring or a video monitoring of the individual or the entity, wherein the apparatus transmits a position or location request message to the monitoring device, wherein the apparatus receives information regarding the position or location of the monitoring computer, wherein the apparatus processes the information regarding the position or location of the monitoring computer with information stored in the database to identify a camera or a video recording device or a plurality of cameras or video recording devices in a vicinity of the monitoring computer or the individual or the entity, and further wherein the apparatus generates a report containing information regarding the position or location of the monitoring computer, information regarding the camera or the video recording device or the plurality of cameras or video recording devices in a vicinity of the monitoring computer or the individual or the entity, and a link or a hyperlink to a picture, a photograph, video information, or live streaming video, obtained by the camera or the video recording device, or obtained by each of the plurality of cameras or video recording devices, wherein the apparatus transmits the report to the user communication device, and further wherein the report is viewable via a display device of the user communication device, wherein the picture, the photograph, the video information, or the live streaming video, obtained by the camera or the video recording device, or obtained by each of the plurality of cameras or video recording devices, is viewable via the electronic forum on the display device.
